(19) United States
(12) Patent Application Publication
(10) Pub. No.: US 2020/0176772 A1
(43) Pub. Date: Jun. 4, 2020

(54) ACTIVE MATERIAL, METHOD FOR PRODUCING ACTIVE MATERIAL, ELECTRODE ASSEMBLY, SECONDARY BATTERY, AND ELECTRONIC APPARATUS

(71) Applicant: SEIKO EPSON CORPORATION, Tokyo (JP)

(72) Inventors: Hitoshi YAMAMOTO, Chino-shi (JP); Tomofumi YOKOYAMA, Matsumoto-shi (JP)

(73) Assignee: SEIKO EPSON CORPORATION, Tokyo (JP)

(21) Appl. No.: 16/697,327

(22) Filed: Nov. 27, 2019

(30) Foreign Application Priority Data
Nov. 29, 2018 (JP) 2018-223234

(51) Int. Cl. H01M 4/525; H01M 4/1315; H01M 10/0525; H01M 4/13915

(52) U.S. Cl. CPC H01M 4/525; H01M 4/13915; H01M 10/0525; H01M 4/1315

(57) ABSTRACT

An active material includes a first oxide that is a composite metal oxide containing lithium and one or more types of elements selected from the group consisting of nickel, manganese, and cobalt, and a second oxide represented by the following formula (1), wherein the second oxide is formed in portions of a surface and an inside of the first oxide: LiₚNiₓMn_{2-x-y}CO_{y}O_{2-q}F_{q} (1). In the formula (1), p, q, x, and y are real numbers satisfying 0.98≤p≤1.07, 0<q≤0.35, 0≤x≤1, and 0≤y≤1, respectively.

The present application is based on, and claims priority from JP Application Serial Number 2018-223234, filed on Nov. 29, 2018, the disclosure of which is hereby incorporated by reference herein in its entirety.

### BACKGROUND

### 1. Technical Field

The present application relates to an active material, a method for producing an active material, an electrode assembly, a secondary battery, and an electronic apparatus.

### 2. Related Art

Heretofore, there has been known a battery using lithium cobalt oxide as a positive electrode active material. For example, JP-A-2002-151077 (Patent Document 1) discloses a positive electrode active material for use in a nonaqueous electrolyte secondary battery in which surfaces of particles of a lithium cobalt oxide particle powder are partially coated with aluminum oxide, and a coating amount of the aluminum oxide is from 1 to 4 mol % with respect to cobalt in the lithium cobalt oxide particle powder. A positive electrode active material in which surfaces of particles of a lithium cobalt oxide particle powder are partially coated with zirconium oxide other than aluminum oxide is also known.

However, it is not easy to homogeneously form aluminum oxide or zirconium oxide at surfaces of particles of a lithium cobalt oxide particle powder, and there is a limit to the improvement of charge-discharge characteristics of the battery.

### SUMMARY

An active material according to an aspect of the present application includes a composite metal oxide represented by the following formula (1), wherein the composite metal oxide contains lithium and fluorine, and also contains one or more types of elements selected from the group consisting of nickel, manganese, and cobalt.

LiₚNiₓMn_{2-x-y}CO_{y}O_{2-q}F_{q} (1)

In the formula (1), p, q, x, and y are real numbers satisfying 0.98≤p≤1.07, 0<q≤0.35, 0≤x≤1, and 0≤y≤1, respectively.

In the active material described above, a fluorine concentration at a surface of the composite metal oxide may be larger than a fluorine concentration inside the composite metal oxide.

In the active material described above, the composite metal oxide may include LiCoOF, LiNiOF, LiMn₂O₃F, LiMn₂O₂F, or Liₚ(Mn_{1-x-y}CO_{y})OF.

A method for producing an active material according to an aspect of the present application includes a first step of mixing a lithium composite metal oxide containing lithium and one or more types of elements selected from the group consisting of nickel, manganese, and cobalt with a fluorinated organic polymer, thereby obtaining a mixture, a second step of heating the mixture in an inert gas atmosphere, thereby obtaining an intermediate product including a composite metal oxide represented by the following formula (1), and a third step of sintering the intermediate product in the atmosphere or in dry air.

LiₚNiₓMn_{2-x-y}CO_{y}O_{2-q}F_{q} (1)

In the formula (1), p, q, x, and y are real numbers satisfying 0.98≤p≤1.07, 0<q≤0.35, 0≤x≤1, and 0≤y≤1, respectively.

A method for producing an active material according to an aspect of the present application includes a first step of mixing a lithium composite metal oxide containing lithium and one or more types of elements selected from the group consisting of nickel, manganese, and cobalt with a fluorinated organic polymer, thereby obtaining a mixture, a second step of heating the mixture in a reducing gas atmosphere, thereby obtaining an intermediate product including a composite metal oxide represented by the following formula (1), and a third step of sintering the intermediate product in the atmosphere or in dry air.

LiₚNiₓMn_{2-x-y}CO_{y}O_{2-q}F_{q} (1)

In the formula (1), p, q, x, and y are real numbers satisfying 0.98≤p≤1.07, 0<q≤0.35, 0≤x≤1, and 0≤y≤1, respectively.

In the method for producing an active material described above, the fluorinated organic polymer may be polyvinylidene fluoride.

In the method for producing an active material described above, in the first step, the lithium composite metal oxide and the polyvinylidene fluoride may be mixed at a molar ratio of 1:1.

In the method for producing an active material described above, the fluorinated organic polymer may be polytetrafluoroethylene.

In the method for producing an active material described above, in the first step, the lithium composite metal oxide and the polytetrafluoroethylene may be mixed at a molar ratio of 1:0.5.

An electrode assembly according to an aspect of the present application includes any of the active materials described above and an electrolyte.

A secondary battery according to an aspect of the present application includes the electrode assembly described above and a current collector.

An electronic apparatus according to an aspect of the present application includes the secondary battery described above.

### BRIEF DESCRIPTION OF THE DRAWINGS

FIG. 1 is a schematic perspective view showing a configuration of a lithium battery as a secondary battery according to a first embodiment.

FIG. 2 is a schematic cross-sectional view showing a configuration of a lithium battery.

FIG. 3 is a graph showing charge-discharge characteristics of lithium batteries.

FIG. 4 is a process flow diagram showing a method for producing a lithium battery.

FIG. 5 is a process flow diagram of Step S2.

FIG. 6 is a view showing preparation of an electrolyte mixture.

FIG. 7 is a view showing molding of a first active material pre-molded body.

FIG. 8 is a view illustrating application of an electrolyte mixture to a first active material molded body.

FIG. 9 is a view showing molding of an electrolyte and an electrolyte layer composed of LCBO.

FIG. 10 is a table showing compositions of active material portions according to Examples and Comparative Examples.

FIG. 11 is a view showing XRD charts of Example 1 and Comparative Example 1.

FIG. 12 is a view showing a Raman scattering spectrum of Example 1.

FIG. 13 is a view showing an SEM-EDS spectrum of an active material portion of Example 1.

FIG. 14 is a view showing SEM-EDS mapping of the active material portion of Example 1.

FIG. 15 is a table showing evaluation results of electrical conductivities of the active material portions of Examples and Comparative Examples.

FIG. 16 is a table showing compositions of electrolytes of Examples.

FIG. 17 is a table showing configurations of active materials and electrolytes of Examples and Comparative Examples.

FIG. 18 is a table showing charge and discharge conditions and evaluation results of lithium batteries of Examples and Comparative Examples.

FIG. 19 is a schematic view showing a configuration of a wearable apparatus as an electronic apparatus according to a second embodiment.

### DESCRIPTION OF EXEMPLARY EMBODIMENTS

Hereinafter, embodiments of the present disclosure will be described with reference to the drawings. Note that the embodiments described below are not intended to unduly limit the content of the present disclosure described in the appended claims, and all the configurations described in the embodiments are not necessarily essential components of the present disclosure. Further, in the following respective drawings, in order to make respective members have a recognizable size, the respective members are shown by being appropriately enlarged or reduced in size.

### First Embodiment

### Secondary Battery

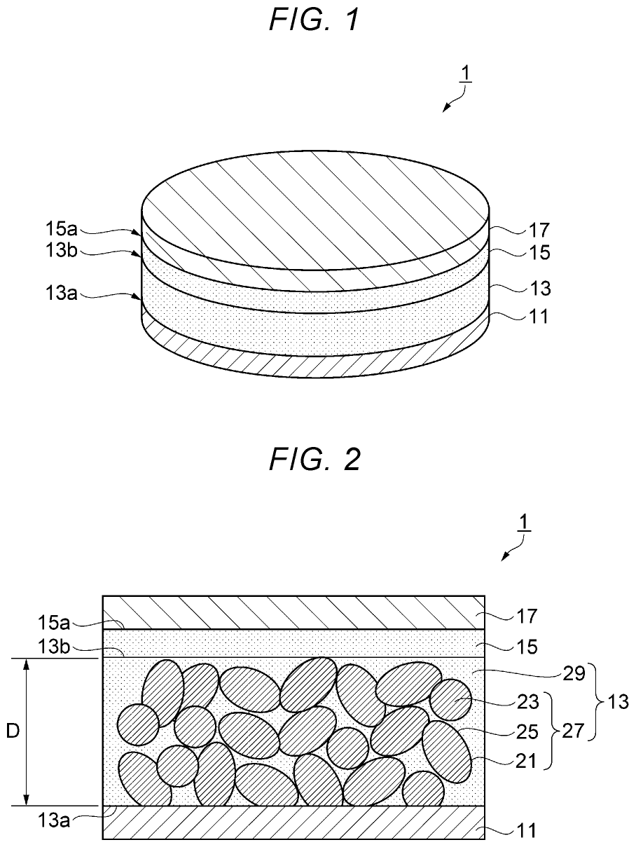

First, a secondary battery according to this embodiment will be described with reference to FIG. 1. In this embodiment, a lithium battery will be described as an example of the secondary battery. FIG. 1 is a schematic perspective view showing a configuration of a lithium battery as the secondary battery according to a first embodiment.

As shown in FIG. 1, a lithium battery 1 of this embodiment includes a positive electrode 13 as an electrode assembly including an electrolyte 29 (see FIG. 2), and an active material portion 27 (see FIG. 2) as an active material, a negative electrode 17 provided at one side of the positive electrode 13 through an electrolyte layer 15, and a first current collector 11 as a current collector provided in contact with the other side of the positive electrode 13.

That is, the lithium battery 1 is a stacked body in which the first current collector 11, the positive electrode 13, the electrolyte layer 15, and the negative electrode 17 are sequentially stacked. In the electrolyte layer 15, a face in contact with the negative electrode 17 is defined as one face 15a, and in the positive electrode 13, a face in contact with the first current collector 11 is defined as a front face 13a, and in the positive electrode 13, a face opposite to the front face 13a is defined as a rear face 13b. A second current collector (not shown) may be provided as appropriate for the electrolyte layer 15 through the negative electrode 17, and the lithium battery 1 may have a current collector that is in contact with at least one of the positive electrode 13 and the negative electrode 17.

### Current Collector

For the first current collector 11 and the second current collector, any forming material can be suitably used as long as the forming material does not cause an electrochemical reaction with the positive electrode 13 and the negative electrode 17 and has an electron conduction property. Examples of the forming material of the first current collector 11 and the second current collector include one type of metal (metal simple substance) selected from the group consisting of copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and palladium (Pd), alloys containing one or more types of metal elements selected from the above-mentioned group, electrically conductive metal oxides such as ITO (Tin-doped Indium Oxide), ATO (Antimony-doped Tin Oxide), and FTO (Fluorine-doped Tin Oxide), and metal nitrides such as titanium nitride (TiN), zirconium nitride (ZrN), and tantalum nitride (TaN).

As the form of the first current collector 11 and the second current collector, other than a thin film of the above-mentioned forming material having an electron conduction property, an appropriate form such as a metal foil, a plate form, a mesh-like form, a lattice-like form, or a paste obtained by kneading an electrically conductive fine powder together with a thickener can be selected according to the intended purpose. The thickness of such a first current collector 11 and a second current collector is not particularly limited, but is, for example, about 20 μm.

Subsequently, structures of the positive electrode 13, the electrolyte layer 15, etc. included in the lithium battery 1 will be described with reference to FIG. 2. FIG. 2 is a schematic cross-sectional view showing a structure of the lithium battery.

### Positive Electrode

The positive electrode 13 as the electrode assembly including the active material portion 27 and the electrolyte 29 will be described. A plurality of pores of the active material portion 27 in the positive electrode 13 communicate with one another in a mesh-like form inside the active material portion 27. Further, due to the contact of a plurality of active material particles 21 with one another, an electron conduction property of the active material portion 27 is ensured. The electrolyte 29 is provided so as to fill up the plurality of pores of the active material portion 27. That is, the active material portion 27 and the electrolyte 29 are combined to form the positive electrode 13 (electrode assembly) Therefore, when the active material portion 27 has a plurality of pores, the contact area between the active material portion 27 and the electrolyte 29 becomes large as compared with a case where the active material portion 27 does not have a plurality of pores or a case where even if the active material portion 27 has a plurality of pores, the electrolyte 29 is not provided up to the inside of the pores. Due to this, the interface resistance is reduced, and it becomes possible to achieve favorable charge transfer at the interface between the active material portion 27 and the electrolyte 29.

The active material portion 27 as the active material has a plurality of pores communicating with one another in a mesh-like form inside the active material portion 27 as described above and has a so-called porous form. In FIG. 2, the active material particles 21 are schematically shown and the actual particle diameters or sizes are not necessarily the same. Further, the active material portion 27 has a form in which a plurality of active material particles 21 are sintered, that is, at least some of the active material particles 21 do not have a particulate form. The active material portion 27 (active material particle 21) includes a composite metal oxide, and the composite metal oxide includes a first active material 23 and a second active material 25. The first active material 23 is present at least inside the active material particle 21, and the second active material 25 is present in a portion near the surface of the active material particle 21 and inside the active material particle, and is formed so as to exist in portions of the surface and the inside of the first active material 23. In this case, the lithium battery 1 in which the interface resistance between the adjacent active material particles 21, the interface resistance between the active material portion 27 and the electrolyte 29, or the interface resistance between the active material portion 27 and the electrolyte layer 15, or the like is suppressed, so that the charge-discharge characteristics are improved is obtained.

The second active material 25 may be formed only in a portion of the surface of the first active material 23, and may be formed in all the region that is the surface of the first active material 23 exposed in a void. According to this, it can be said that the second active material 25 is present also inside the active material portion 27 (positive electrode 13) from the front face 13a to the rear face 13b in the active material portion 27 (positive electrode 13). In other words, when a distance from the front face 13a to the rear face 13b is denoted by D, it can be said that the second active material 25 is present at a position of c×D (provided that c is a real number satisfying 0≤c≤1). In a portion where the active material particles 21 are in contact with one another, the first active materials 23 are in contact with one another, and the second active material 25 is not present between the first active materials 23. The second active material 25 is present only near the surfaces of the active material particles 21 exposed in the plurality of pores of the active material portion 27. This configuration can contribute to the improvement of the battery characteristics (charge-discharge characteristics) as compared with a case where the second active material 25 is present only near the front face 13a or the rear face 13b of the active material portion 27 (positive electrode 13).

As the first active material 23 and the second active material 25, a material having a structure in which oxygen (O) in a lithium composite metal oxide is partially replaced (substituted) with fluorine (F) is used. Here, the lithium composite metal oxide refers to an oxide, which contains lithium and at the same time contains two or more types of metal elements as a whole, and in which the existence of oxoacid ions is not observed.

Examples of the lithium composite metal oxide include composite metal oxides containing lithium (Li) and also containing one or more types of elements selected from nickel (Ni), manganese (Mn), and cobalt (Co). Such a composite metal compound is not particularly limited, however, specific examples thereof include LiCoO₂, LiNiO₂, LiMn₂O₄, Li₂Mn₂O₃, and NMC (Liₚ (Mn_{1-x-y}C_{y})O₂.

The first active material 23 and the second active material 25 are formed by including a material represented by the following formula (1).

LiₚNiₓMn_{2-x-y}CO_{y}O_{2-q}F_{q} (1)

In the formula (1), p, q, x, and y are real numbers satisfying 0.98≤p≤1.07, 0<q≤0.35, 0≤x≤1, and 0≤y≤1, respectively.

Examples of the first active material 23 and the second active material 25 include LiCoO_{2-q}F_{q}, LiNiO_{2-q}F_{q}, LiMnO_{2-q}F_{q}, Li₂Mn₂O_{2-q}F_{q}, and Liₚ (NiₓMn_{1-x-y}Co_{y})O_{2-q}F_{q}.

Since the first active material 23 and the second active material 25 have a structure as described above, electron transfer is smoothly performed between the active material particles 21, that is, the electrical conductivity is improved, and it becomes possible to reduce the resistance at the interface between the active material portion 27 and the below-mentioned electrolyte 29 or suppress the formation of a biproduct, in other words, improve the lithium ion conduction property. As a result, the active material portion 27 can favorably exhibit a function as the active material, and the charge-discharge characteristics of the lithium battery 1 are improved.

Further, it is preferred that the active material particle 21 has a fluorine concentration gradient, and the fluorine concentration at the surface of the active material particle 21 (composite metal oxide) is preferably larger than the fluorine concentration inside the active material particle 21 (composite metal oxide). That is, the concentration of fluorine contained in the first active material 23 is preferably larger than the concentration of fluorine contained in the second active material. According to this, electron transfer is smoothly performed between the active material particles 21, that is, the electrical conductivity is improved, and it becomes possible to reduce the resistance at the interface between the active material portion 27 and the below-mentioned electrolyte 29 or suppress the formation of a biproduct, in other words, improve the lithium ion conduction property. As a result, the active material portion 27 can favorably exhibit a function as the active material, and the charge-discharge characteristics of the lithium battery 1 are improved.

The positive electrode 13 (composite metal oxide) may contain any of LiCoOF, LiNiOF, LiMn₂O₃F, LiMn₂O₂F, and Liₚ(Mn_{1-x-y}CO_{y})OF that is not included in the above formula (1). In this case, the lithium battery 1 in which the interface resistance between the adjacent active material particles 21, the interface resistance between the active material portion 27 and the electrolyte 29, or the interface resistance between the active material portion 27 and the electrolyte layer 15, or the like is suppressed, so that the charge-discharge characteristics are improved is obtained.

The second active material 25 may be present in a scattered manner in a region where the active material particles 21 are exposed in the plurality of pores of the active material portion 27, but is preferably present in a layer state so as to cover the first active material 23.

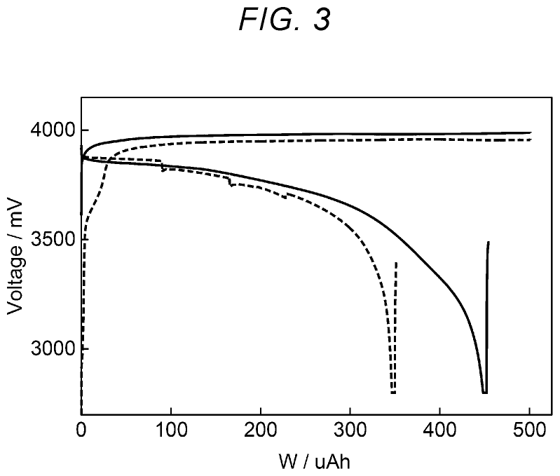

According to this, the second active material 25 is present at the interface between the active material portion 27 and the electrolyte 29, so that the lithium ion conduction property at the interface between the active material portion 27 and the electrolyte 29 is improved. In addition, the inclusion of fluorine in the active material portion 27 makes it easy for the transition metal element contained in the electrolyte 29 to have a valence suitable for charge-discharge characteristics of the lithium battery 1 of this embodiment, so that the charge-discharge characteristics are improved. FIG. 3 is a graph showing the charge-discharge characteristics of lithium batteries. In FIG. 3, the solid lines indicate the charge-discharge characteristics of the lithium battery 1 of this embodiment, that is, when the active material portion 27 contains fluorine, and the broken lines indicate the charge-discharge characteristics of a lithium battery in which the active material portion 27 does not contain fluorine. The charge-discharge characteristics indicated by the broken lines have an inflection point during charging. This indicates that, for example, when the transition metal element is Sb or Ta, the element is generally likely to be trivalent, however, the valence changes to pentavalence during charging, and energy is used at that time. On the other hand, the charge-discharge characteristics indicated by the solid lines do not have an inflection point during charging. Accordingly, it can be said that the inclusion of fluorine in the active material portion 27 provides an effect that the transition metal element is likely to have a suitable valence during charging and discharging, for example, when the transition metal element is Sb or Ta, the transition metal element is likely to be pentavalent.

The active material portion 27 has a bulk density of preferably 50% or more and 90% or less, more preferably 50% or more and 70% or less. When the active material portion 27 has such a bulk density, the surface area of the inside of the pore of the active material portion 27 is enlarged, and the contact area between the active material portion 27 and the electrolyte 29 is easily increased. According to this, in the lithium battery 1, it becomes easier to increase the capacity than in the related art.

When the above-mentioned bulk density is denoted by β (%), the apparent volume including the pores of the active material portion 27 is denoted by v, the mass of the active material portion 27 is denoted by w, and the density of the particles of the active material particles 21 is denoted by ρ, the following mathematical formula (2) is established. According to this, the bulk density can be determined.

β={w/(v·ρ)}×100 (2)

In order to control the bulk density of the active material portion 27 to fall within the above range, the average particle diameter (median diameter) of the active material particles 21 is preferably set to 0.3 μm or more and 10 μm or less, and is more preferably 0.5 μm or more and 5 μm or less. The average particle diameter of the active material particles 21 can be measured by, for example, dispersing the active material particles 21 in n-octyl alcohol at a concentration within a range of 0.1 mass % or more and 10 mass % or less, and determining the median diameter using a light scattering particle size distribution analyzer, Nanotrac (trademark) UPA-EX250 (product name, MicrotracBEL Corporation).

The bulk density of the active material portion 27 may also be controlled by using a pore forming material in the step of forming the active material portion 27.

The resistivity of the active material portion 27 is preferably 700 Ω·cm or less. When the active material portion 27 has such a resistivity, a sufficient output can be obtained in the lithium battery 1. The resistivity can be determined by adhering a copper foil as an electrode to the front face 13a of the active material portion 27 (positive electrode 13), and performing DC polarization measurement.

In the active material portion 27, the plurality of pores communicate with one another in a mesh-like form inside, and also the active material portions 27 are coupled to one another to form a mesh-like structure. For example, LiCoO₂ that is an active material is known to have anisotropy in the electron conduction property in a crystal. Due to this, in a configuration in which pores extend in a specific direction such that the pores are formed by machining, the electron conduction property may be decreased depending on the direction of the electron conduction property in a crystal. On the other hand, in this embodiment, the active material portion 27 has a mesh-like structure, and therefore, an electrochemically active continuous surface can be formed regardless of the anisotropy in the electron conduction property or ion conduction property in a crystal. Due to this, a favorable electron conduction property can be ensured regardless of the type of the forming material to be used.

In the positive electrode 13, the contained amount of the binder (binding agent) for binding the plurality of active material particles 21 or the pore forming material for adjusting the bulk density of the active material portion 27 is preferably reduced as much as possible. When the binder or the pore forming material remains in the active material portion 27 (positive electrode 13), such a component may sometimes adversely affect the electrical characteristics, and therefore, it is necessary to remove such a material by carefully performing heating in a post-process. Specifically, in this embodiment, the mass loss percentage when the positive electrode 13 is heated at 400° C. for 30 minutes is set to 5 mass % or less. The mass loss percentage is preferably 3 mass % or less, more preferably 1 mass % or less, and further more preferably, the mass loss is not observed or is within the measurement error range. When the positive electrode 13 has such a mass loss percentage, the amount of a solvent or adsorbed water to be evaporated, an organic material to be vaporized by combustion or oxidation under a predetermined heating condition, or the like is reduced. According to this, the electrical characteristics (charge-discharge characteristics) of the lithium battery 1 can be further improved.

The mass loss percentage of the positive electrode 13 can be determined from the values of the mass of the positive electrode 13 before and after heating under a predetermined heating condition using a thermogravimetric/differential thermal analyzer (TG-DTA).

In the lithium battery 1, when a direction away from the first current collector 11 in the normal direction (the upper side of FIG. 2) is defined as “upward direction”, the surface at the upper side of the positive electrode 13, that is, the rear face 13b is in contact with the electrolyte layer 15. The surface at the lower side of the positive electrode 13, that is, the front face 13a is in contact with the first current collector 11. In the positive electrode 13, the upper side in contact with the electrolyte layer 15 is “one side”, and the lower side in contact with the first current collector 11 is “the other side”.

At the front face 13a of the positive electrode 13, the active material portion 27 is exposed. Therefore, the active material portion 27 and the first current collector 11 are provided in contact with each other and both are electrically coupled to each other. The electrolyte 29 is provided up to the inside of the pores of the active material portion 27 and is in contact with the surface of the active material portion 27 other than the face in contact with the first current collector 11, that is, the surface of the active material portion 27 (active material particles 21) exposed in voids inside the active material portion 27.

In the positive electrode 13 having such a configuration, due to the contact area between the first current collector 11 and the active material portion 27, the contact area between the active material portion 27 and the electrolyte 29 is increased. Due to this, the interface between the active material portion 27 and the electrolyte 29 hardly becomes a bottleneck of charge transfer, and therefore, favorable charge transfer is easily ensured as the positive electrode 13, and thus, it is possible to achieve high capacity and high output in the lithium battery 1 using the positive electrode 13.

### Electrolyte

Next, the configuration of the electrolyte 29 included in the positive electrode 13 will be described.

As the electrolyte 29, a crystalline or amorphous solid electrolyte composed of an oxide, a sulfide, a halide, a nitride, a hydride, a boride, or the like of lithium is used.

Examples of the oxide crystalline material include Li_{0.35}La_{0.55}TiO₃, Li_{0.2}La_{0.27}NbO₃, and a perovskite-type crystal or a perovskite-like crystal in which the elements in a crystal thereof are partially substituted with N, F, Al, Sr, Sc, Nb, Ta, Sb, a lanthanoid element, or the like, Li₇La₃Zr₂O₁₂, Li₅La₃Nb₂O₁₂, Li₅BaLa₂TaO₁₂, and a garnet-type crystal or a garnet-like crystal in which the elements in a crystal thereof are partially substituted with N, F, Al, Sr, Sc, Nb, Ta, Sb, a lanthanoid element, or the like, Li_{1.3}Ti_{1.7}Al_{0.3} (PO₄)₃, Li_{1.4}Al_{0.4}Ti_{1.6}(PO₄)₃, Li_{1.4}Al_{0.4}Ti_{1.4}Ge_{0.2}(PO₄)₃, and a NASICON-type crystal in which the elements in a crystal thereof are partially substituted with N, F, Al, Sr, Sc, Nb, Ta, Sb, a lanthanoid element, or the like, a LISICON-type crystal such as Li₁₄ZnGe₄O₁₆, and other crystalline materials such as Li_{3.4}V_{0.6}Si_{0.4}O₄ and Li_{3.6}V_{0.4}Ge_{0.6}O₄.

Examples of the sulfide crystalline material include Li₁₀GeP₂S₁₂, Li_{9.6}P₃S₁₂, Li_{9.54}Si_{1.74}P_{1.44}S_{11.7}Cl_{0.3}, and Li₃PS₄.

Examples of other amorphous materials include Li₂O-TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₃PO₄—Li₄SiO₄, Li₄SiO₄—Li₄ZrO₄, SiO₂—P₂O₅—Li₂O, SiO₂—P₂O₅—LiCl, Li₂O—LiCl—B₂O₃, LiI, LiI—CaI, LiI—CaO, LiAlCl₄, LiAlF₄, LiF—Al₂O₃, LiBr—Al₂O₃, LiI—Al₂O₃, Li_{2.88}PO_{3.73}N_{0.14}, Li₃NI₂, Li₃N—LiI—LiOH, Li₃N—LiCl, Li₆NBr₃, Li₂S—SiS₂, Li₂S—SiS₂—LiI, and Li₂S—SiS₂—P₂S₅. Above all, Li₂₊ₓC₁₋ₓBₓO₃ that is a lithium composite oxide containing carbon (C) and boron (B) and that has a lower melting point than the active material portion 27 or an analogous material such as Li₃BO₃ is particularly preferably used.

### Electrolyte Layer

The electrolyte layer 15 is provided between the positive electrode 13 and the negative electrode 17. The electrolyte layer 15 does not include the active material particles 21. The electrolyte layer 15 can be formed using the same forming material as that of the electrolyte 29 included in the positive electrode 13. By interposing the electrolyte layer 15 that does not include the active material particles 21 between the positive electrode 13 and the negative electrode 17, the positive electrode 13 and the negative electrode 17 are hardly electrically coupled to each other, and the occurrence of a short circuit is suppressed. When the electrolyte layer 15 is formed using the same forming material as that of the electrolyte 29, the electrolyte layer 15 and the electrolyte 29 may be formed simultaneously at the time of production. That is, in the production step of the lithium battery 1, the formation of the positive electrode 13 and the formation of the electrolyte layer 15 may be performed at a time. Further, when the electrolyte layer 15 is formed using a different forming material from that of the electrolyte 29, the positive electrode 13 and the electrolyte layer 15 are formed in separate production steps.

The thickness of the electrolyte layer 15 is preferably 0.1 μm or more and 100 μm or less, more preferably 0.2 μm or more and 10 μm or less. By setting the thickness of the electrolyte layer 15 within the above range, the internal resistance of the electrolyte layer 15 is decreased, and the occurrence of a short circuit between the positive electrode 13 and the negative electrode 17 can be suppressed.

On the one face 15a (the face in contact with the negative electrode 17) of the electrolyte layer 15, a relief structure such as a trench, a grating, or a pillar may be provided by combining various molding methods and processing methods as needed.

### Negative Electrode

The negative electrode 17 is configured to contain a negative electrode active material. Examples of the negative electrode active material include niobium pentoxide (Nb₂O₅), vanadium pentoxide (V₂O₅), titanium oxide (TiO₂), indium oxide (In₂O₃), zinc oxide (ZnO), tin oxide (SnO₂), nickel oxide (NiO), tin (Sn)-doped indium oxide (ITO), aluminum (Al)-doped zinc oxide (AZO), gallium (Ga)-doped zinc oxide (GZO), antimony (Sb)-doped tin oxide (ATO), fluorine (F)-doped tin oxide (FTO), an anatase phase of TiO₂, lithium composite oxides such as Li₄Ti₅O₁₂ and Li₂Ti₃O₇, metals and alloys such as lithium (Li), silicon (Si), tin (Sn), a silicon-manganese alloy (Si—Mn), a silicon-cobalt alloy (Si—Co), a silicon-nickel alloy (Si—Ni), indium (In), and gold (Au), a carbon material, and a material obtained by intercalation of lithium ions between layers of a carbon material. In this embodiment, lithium (Li, also referred to as metallic lithium) is used in consideration of the battery capacity.

The thickness of the negative electrode 17 is preferably from approximately about 50 nm to 100 μm, but can be arbitrarily designed according to a desired battery capacity or material properties.

The lithium battery 1 has, for example, a circular disk shape, and the size of the outer shape thereof is such that the diameter is about 10 mm and the thickness is about 200 μm. In addition to being small and thin, the lithium battery 1 can be charged and discharged, and is capable of obtaining a large output energy, and therefore can be suitably used as a power supply source (power supply) for a portable information terminal or the like. The shape of the lithium battery 1 is not limited to a circular disk shape, and may be, for example, a polygonal disk shape. Such a thin lithium battery 1 may be used alone or a plurality of lithium batteries 1 may be stacked and used. When the lithium batteries 1 are stacked, in the lithium battery 1, the first current collector 11 and the second current collector are not necessarily essential components, and a configuration in which one of the current collectors is included may be adopted.

### Method for Producing Battery

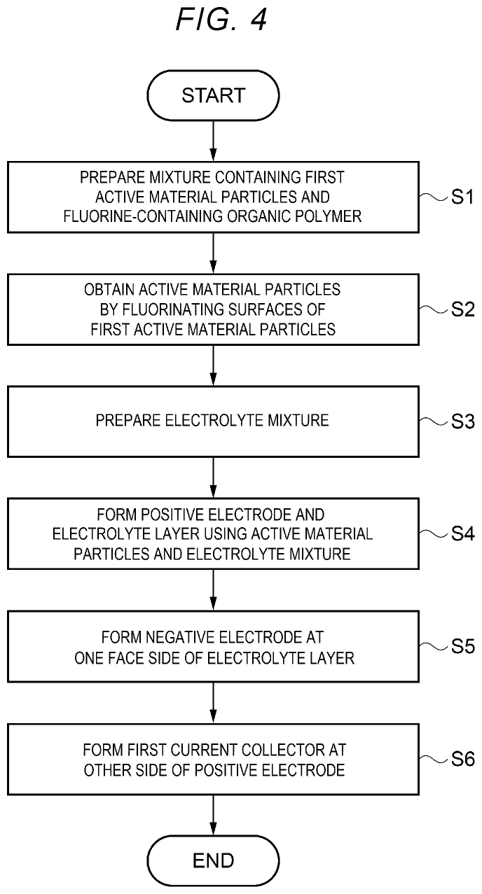

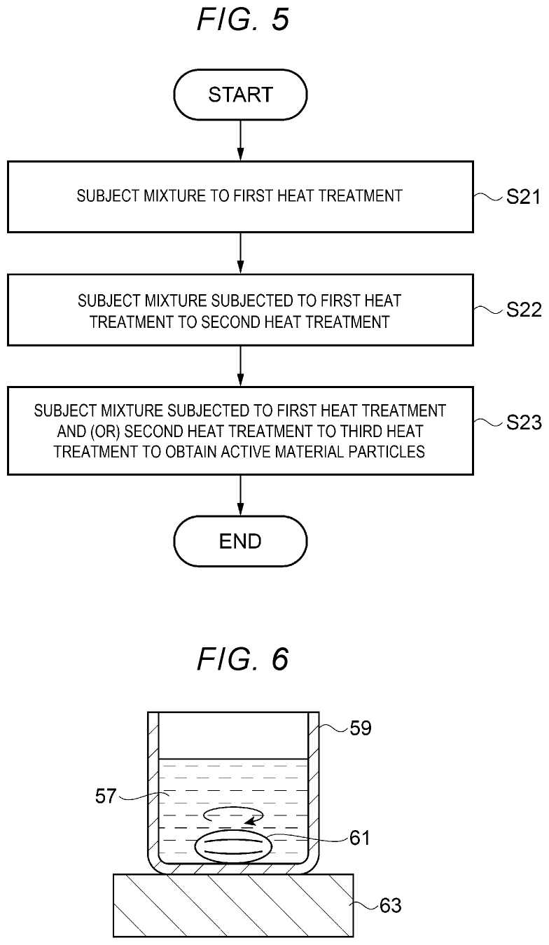

A method for producing the lithium battery 1 as the secondary battery according to this embodiment will be described with reference to FIGS. 4 and 5. FIG. 4 is a process flow diagram showing the method for producing the lithium battery. FIG. 5 is a process flow diagram of Step S2. The process flow shown in FIG. 4 is an example, and the method is not limited thereto.

As shown in FIG. 4, the method for producing the lithium battery 1 of this embodiment includes the following steps. In Step S1 (first step), a mixture containing a lithium composite metal oxide and a fluorinated organic polymer is prepared. In Step S2 (second step), a surface of the lithium composite metal oxide is fluorinated, whereby the active material particles 21 (intermediate product) are obtained. In Step S3, precursors as the raw materials of the electrolyte 29 and the electrolyte layer 15 are dissolved in a solvent to form solutions, followed by mixing the solutions, whereby an electrolyte mixture 57 (see FIG. 6) is prepared. In Step S4 (third step), by using the active material particles 21 (intermediate product) and the electrolyte mixture 57, the positive electrode 13 as the electrode assembly and the electrolyte layer 15 are formed. In Step S5, the negative electrode 17 is formed at the one face 15a side of the electrolyte layer 15. In Step S6, the first current collector 11 is formed at the other side (front face 13a) of the positive electrode 13.

Here, with respect to the method for producing the lithium battery 1, the step of forming the electrolyte 29 will be described by showing a liquid phase method as an example.

### Preparation of Mixture

In Step S1 (first step), a lithium composite metal oxide and a fluorinated organic polymer are mixed, whereby a mixture is prepared by a wet method. In the wet method, hexane is used as a solvent, however, after wet mixing, hexane that is the solvent is removed, whereby a mixture is obtained.

The lithium composite metal oxide refers to an oxide, which contains lithium and at the same time contains two or more types of metal elements as a whole, and in which the existence of oxoacid ions is not observed.

Examples of the lithium composite metal oxide include composite metal oxides containing lithium (Li) and also containing one or more types of elements selected from nickel (Ni), manganese (Mn), and cobalt (Co). Such a composite metal compound is not particularly limited, however, specific examples thereof include LiCoO₂, LiNiO₂, LiMn₂O₄, Li₂Mn₂O₃, and NMC (Liₚ (Mn_{1-x-y}C_{y})O₂).

A fluorine-containing organic polymer is a polymer in which hydrogen in an organic polymer containing carbon and hydrogen is at least partially substituted with fluorine, and polyvinylidene fluoride (hereinafter referred to as PVDF), polytetrafluoroethylene (hereinafter referred to as PTFE), or the like is favorably selected. In PVDF or PTFE, carbon (C) contained in vinylidene fluoride or tetrafluoroethylene that is a structural unit (monomer) thereof is not much, and in a second heat treatment in the below-mentioned Step S2, when carbon flies in the atmosphere as carbon dioxide, carbon is less likely to remain in the active material portion 27, that is, the active material portion 27 with few impurities can be obtained, and an effect that the characteristics of the lithium battery 1 are not deteriorated is exhibited.

It is preferred to prepare the mixture of the lithium composite metal oxide and the fluorine-containing organic polymer so that the number ratio of oxygen (O) contained per mole of the lithium composite metal oxide and fluorine (F) contained per mole of the fluorine-containing organic polymer converted into a structural unit (hereinafter referred to as O:F ratio) is 1:2. When it is assumed that all oxygen (O) contained in the first active material particles is substituted with (F), the minimum required amount of the fluorine-containing organic polymer is such an amount that the mixture is prepared so that the O:F ratio is 1:1. However, it is difficult for all (F) in the fluorine-containing organic polymer to contribute to the reaction. Further, when the ratio of F is higher than the O:F ratio of 1:2, carbon is likely to remain in the active material portion 27, and the characteristics of the lithium battery 1 may be deteriorated. Therefore, it is preferred to prepare the mixture so that the O:F ratio is 1:2. According to this, the active material portion 27 in which the first active material particles are efficiently fluorinated, and impurities are few can be obtained, and an effect that the characteristics of the lithium battery 1 are not deteriorated is exhibited.

For example, when PVDF is selected as the fluorine-containing organic polymer, 1 mol of fluorine (F₂) is contained in 1 mol of vinylidene fluoride that is the structural unit of PVDF, and therefore, the lithium composite metal oxide and the fluorine-containing organic polymer converted into a structural unit are mixed at a molar ratio of 1:1.

Further, for example, when PTFE is selected as the fluorine-containing organic polymer, 2 mol of fluorine (F₂) is contained in 1 mol of tetrafluoroethylene that is the structural unit of PTFE, and therefore, the lithium composite metal oxide and the fluorine-containing organic polymer converted into a structural unit are mixed at a molar ratio of 1:0.5.

The number of carbon atoms contained in 1 mol of structural unit of each of PTFE and PVDF is the same, that is, when PTFE is selected as the fluorine-containing organic polymer, carbon present in the mixture before heating is not much, and the active material portion 27 with few impurities can be obtained, and an effect that the characteristics of the lithium battery 1 are not deteriorated is exhibited.

However, the cost of obtaining PTFE is high as compared with PVDF, and therefore, when PVDF is selected as the fluorine-containing organic polymer, an effect that the active material portion 27 with few impurities can be obtained at low cost is exhibited.

### Fluorination of Active Material Particles

Step S2 (second step) is a step of fluorinating the surface of the lithium composite metal oxide, and will be described with reference to FIG. 5. FIG. 5 is a process flow diagram of Step S2. Step S2 includes Step S21 of subjecting the mixture to a first heat treatment, Step S22 of subjecting the mixture subjected to the first heat treatment to a second heat treatment, and Step S23 of subjecting the mixture subjected to the first heat treatment and (or) the second heat treatment to a third heat treatment, thereby obtaining the active material particles (intermediate product). However, Step S22 can also serve as Step S23 as described later, and therefore, Step S22 can be omitted.

In Step S21, the mixture obtained in Step S1 is, for example, placed in a crucible formed of a material that is less likely to react with the mixture such as magnesium oxide (MgO), and is subjected to a heat treatment in an inert gas atmosphere, whereby a first heat treatment is carried out. At this time, the temperature is increased from room temperature at a temperature increasing rate of 4° C./min, and after the temperature reaches 400° C., firing is performed at 400° C. for 20 hours. As the inert gas, for example, argon can be used, but the inert gas is not limited thereto.

The heat treatment may be performed not in an inert gas atmosphere, but in a reducing gas atmosphere. In this case, for example, a reducing atmosphere containing argon and hydrogen at a ratio of argon:hydrogen=95:5 to 97:3 is adopted, and other heating conditions are the same as in a case of heating in an inert gas atmosphere. In addition, there is no problem even if the atmosphere is not an inert gas atmosphere or a reducing gas atmosphere, but is a reduced pressure atmosphere.

In Step S22, the mixture subjected to the first heat treatment in Step S21 is subjected to a second heat treatment in which the temperature is increased from room temperature at a temperature increasing rate of 4° C./min in the atmosphere, and after the temperature reaches 400° C., firing is performed at 400° C. for 20 hours. By doing this, carbon in the mixture can be at least partially taken away.

In Step S23, the mixture subjected to the second heat treatment in Step S22 is subjected to a third heat treatment in which the temperature is increased from room temperature at a temperature increasing rate of 1° C./min in the atmosphere, and after the temperature reaches 1000° C., firing is performed at 1000° C. for 8 hours. By doing this, almost all carbon in the mixture can be taken away. Accordingly, it can be said that the above-mentioned Step S22 can also serve as Step S23, and therefore, Step S22 can be omitted.

Further, in Step S23, by setting the temperature increasing rate to 1° C./min, a tar component remaining in the mixture works as a melt, so that the formation of a hard sintered body of the active material particles 21 can be prevented.

By undergoing the above-mentioned steps, the lithium composite metal oxide is partially fluorinated to form a composite metal oxide represented by the following formula (1), whereby the active material particles 21 including the first active material 23 and the second active material 25 are obtained.

LiₚNiₓMn_{2-x-y}CO_{y}O_{2-q}F_{q} (1)

In the formula (1), p, q, x, and y are real numbers satisfying 0.98≤p≤1.07, 0<q≤0.35, 0≤x≤1, and 0≤y≤1, respectively.

Further, the composite metal oxide formed through the above-mentioned steps may contain any of LiCoOF, LiNiOF, LiMn₂O₃F, LiMn₂O₂F, and Li(Mn_{1-x-y}C_{y}) OF that is not included in the above formula (1).

### Preparation of Electrolyte Mixture

In Step S3, the electrolyte mixture 57 is prepared by dissolving each of the precursors as the raw materials of the electrolyte 29 and the electrolyte layer 15 in a solvent to form solutions, followed by mixing these solutions. That is, the electrolyte mixture 57 contains a solvent for dissolving the above-mentioned raw materials (precursors). As the precursors of the electrolyte 29 and the electrolyte layer 15, metal compounds containing elements constituting a crystalline or amorphous material composed of an oxide, a sulfide, a halide, a nitride, a hydride, a boride, or the like of lithium constituting the electrolyte 29 and the electrolyte layer 15 are used.

Examples of a lithium compound include lithium metal salts such as lithium chloride, lithium nitrate, lithium acetate, lithium hydroxide, and lithium carbonate, and lithium alkoxides such as lithiummethoxide, lithium ethoxide, lithium propoxide, lithium isopropoxide, lithium n-butoxide, lithium isobutoxide, lithium sec-butoxide, lithium tert-butoxide, and lithium dipivaloylmethanate, and one or more types in this group can be adopted.

When, for example, lanthanum (La) is contained as the metal constituting the electrolyte 29 and the electrolyte layer 15, examples of a lanthanum compound include lanthanum metal salts such as lanthanum chloride, lanthanum nitrate, and lanthanum acetate, and lanthanum alkoxides such as lanthanum trimethoxide, lanthanum triethoxide, lanthanum tripropoxide, lanthanum triisopropoxide, lanthanum tri-n-butoxide, lanthanum triisobutoxide, lanthanum tri-sec-butoxide, lanthanum tri-tert-butoxide, and lanthanum tris(dipivaloylmethanate), and one or more types in this group can be adopted.

When, for example, neodymium (Nd) is contained as the metal constituting the electrolyte 29 and the electrolyte layer 15, examples of a neodymium compound include neodymium metal salts such as neodymium bromide, neodymium chloride, neodymium fluoride, neodymium oxalate, neodymium acetate, neodymium nitrate, neodymium sulfate, neodymium trimethacrylate, neodymium triacetylacetate, and neodymium tri-2-ethylhexanoate, and neodymium alkoxides such as triisopropoxyneodymium and trimethoxyethoxyneodymium, and one or more types in this group can be adopted.

When, for example, zirconium (Zr) is contained as the metal constituting the electrolyte 29 and the electrolyte layer 15, examples of a zirconium compound include zirconium metal salts such as zirconium chloride, zirconium oxychloride, zirconium oxynitrate, zirconium oxyacetate, and zirconium acetate, and zirconium alkoxides such as zirconium tetramethoxide, zirconium tetraethoxide, zirconium tetrapropoxide, zirconium tetraisopropoxide, zirconium tetra-n-butoxide, zirconium tetraisobutoxide, zirconium tetra-sec-butoxide, zirconium tetra-tert-butoxide, and zirconium tetrakis(dipivaloylmethanate), and one or more types in this group can be adopted.

When, for example, gallium (Ga) is contained as the metal constituting the electrolyte 29 and the electrolyte layer 15, examples of a gallium compound include gallium metal salts such as gallium bromide, gallium chloride, gallium iodide, and gallium nitrate, and gallium alkoxides such as gallium trimethoxide, gallium triethoxide, gallium tri-n-propoxide, gallium triisopropoxide, and gallium tri-n-butoxide, and one or more types in this group can be adopted.

When, for example, antimony (Sb) is contained as the metal constituting the electrolyte 29 and the electrolyte layer 15, examples of an antimony compound include antimony metal salts such as antimony bromide, antimony chloride, and antimony fluoride, and antimony alkoxides such as antimony trimethoxide, antimony triethoxide, antimony triisopropoxide, antimony tri-n-propoxide, antimony triisobutoxide, and antimony tri-n-butoxide, and one or more types in this group can be adopted.

When, for example, tantalum (Ta) is contained as the metal constituting the electrolyte 29 and the electrolyte layer 15, examples of a tantalum compound include tantalum metal salts such as tantalum chloride and tantalum bromide, and tantalum alkoxides such as tantalum pentamethoxide, tantalum pentaethoxide, tantalum pentaisopropoxide, tantalum penta-n-propoxide, tantalum pentaisobutoxide, tantalum penta-n-butoxide, tantalum penta-sec-butoxide, and tantalum penta-tert-butoxide, and one or more types in this group can be adopted.

As the solvent contained in the solutions containing the precursors of the electrolyte 29 and the electrolyte layer 15, a single solvent of water or an organic solvent or a mixed solvent capable of dissolving the above-mentioned metal salt or metal alkoxide is used. The organic solvent is not particularly limited, however, examples thereof include alcohols such as methyl alcohol, ethyl alcohol, n-propyl alcohol, isopropyl alcohol, n-butyl alcohol, allyl alcohol, and ethylene glycol monobutyl ether (2-butoxyethanol), glycols such as ethylene glycol, propylene glycol, butylene glycol, hexylene glycol, pentanediol, hexanediol, heptanediol, and dipropylene glycol, ketones such as dimethyl ketone, methyl ethyl ketone, methyl propyl ketone, and methyl isobutyl ketone, esters such as methyl formate, ethyl formate, methyl acetate, and methyl acetoacetate, ethers such as diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether, organic acids such as formic acid, acetic acid, 2-ethylbutyric acid, and propionic acid, aromatics such as toluene, o-xylene, and p-xylene, and amides such as formamide, N,N-dimethylformamide, N,N-diethylformamide, dimethylacetamide, and N-methylpyrrolidone.

The precursors of the electrolyte 29 and the electrolyte layer 15 described above are dissolved in the above-mentioned solvent, whereby a plurality of solutions containing the precursors of the electrolyte 29 and the electrolyte layer 15, respectively, are prepared. Subsequently, the plurality of solutions are mixed, whereby the electrolyte mixture 57 is prepared. At this time, in addition to lithium, lanthanum, neodymium, and zirconium, one or more types of gallium, antimony, and tantalum are incorporated in the electrolyte mixture 57 at a predetermined ratio according to the composition of the electrolyte 29 and the electrolyte layer 15. At this time, the electrolyte mixture 57 may be prepared by mixing the precursors, and then dissolving the mixture in the solvent without preparing a plurality of solutions containing the precursors, respectively.

Lithium in the composition is sometimes volatilized by heating in a post-process. Therefore, the lithium compound may be excessively blended in advance so that the content thereof in the mixture is more by about 0.05 mol % to 30 mol % with respect to the desired composition according to the heating condition.

The preparation of the electrolyte mixture 57 will be described with reference to FIG. 6. FIG. 6 is a view showing the preparation of the electrolyte mixture. Specifically, for example, as shown in FIG. 6, the plurality of solutions containing the precursors of the electrolyte 29 and the electrolyte layer 15, respectively, are placed in a beaker 59 made of Pyrex (registered trademark). A magnetic stirrer bar 61 is placed therein, and the solutions are mixed while stirring by a magnetic stirrer 63. By doing this, the electrolyte mixture 57 is obtained. Then, the process proceeds to Step S4.

### Formation of Positive Electrode and Electrolyte Layer

In Step S4 (third step), firing is performed using the active material particles 21 (intermediate product) and the electrolyte mixture 57, whereby the positive electrode 13 as the electrode assembly and the electrolyte layer 15 are formed. In Step S4, it is possible to select either one of Step S4a (Formation of Positive Electrode and Electrolyte Layer-a) in which the electrolyte 29 and the electrolyte layer 15 are formed for a first active material molded body 51 as the active material portion 27, whereby the positive electrode 13 and the electrolyte layer 15 are obtained, and Step S4b (Formation of Positive Electrode and Electrolyte Layer-b) in which the below-mentioned electrolyte calcined body and the active material particles 21 are mixed to form the positive electrode 13 and the electrolyte layer 15, whereby the positive electrode 13 and the electrolyte layer 15 are obtained.

### Formation of Positive Electrode and Electrolyte Layer-a

In Step S4a, the electrolyte 29 and the electrolyte layer 15 are formed for the first active material molded body 51 as the active material portion 27, whereby the positive electrode 13 and the electrolyte layer 15 are obtained.

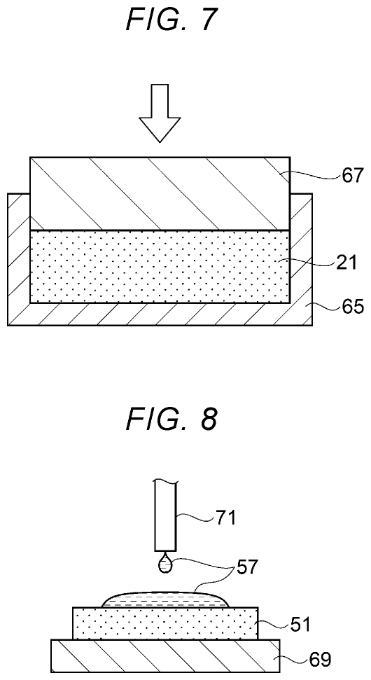

Step S4a will be specifically described with reference to FIG. 7. FIG. 7 is a view showing molding of a first active material pre-molded body. By using a molding device including a die (molding die) 65 and a pressing portion 67, the first active material pre-molded body is molded. A predetermined amount, for example, 150 mg of the active material particles 21 obtained in Step S2 are weighed and filled in the die 65 with a diameter of 10 mm, and pressurization by the pressing portion 67 is performed under a predetermined condition, for example, uniaxial pressing is performed at a pressure of 50 kgN for 4 minutes, whereby the first active material pre-molded body having a thickness of about 100 μm is prepared. The first active material pre-molded body is placed on a substrate and fired by performing a fourth heat treatment using, for example, an electric muffle furnace. A firing temperature of the fourth heat treatment is preferably 850° C. or higher and lower than the melting point of the active material particles 21. By doing this, the plurality of active material particles 21 are sintered to one another, whereby the first active material molded body 51 (active material portion 27) that is an integrated porous sintered body is obtained. By setting the firing temperature to 850° C. or higher, sintering sufficiently proceeds and also the electron conduction property between the adjacent active material particles 21 is ensured. By setting the firing temperature to a temperature lower than the melting point of the positive electrode active material, excessive volatilization of lithium in the crystal of the active material particles 21 is suppressed, and the lithium ion conduction property is maintained. That is, it becomes possible to ensure the capacity of the active material portion 27. In the fourth heat treatment, for example, firing is performed in the atmosphere or in dry air at 1000° C. for 8 hours.

The first active material molded body 51 may be formed by including an organic material such as a binder (binding agent) for binding the active material particles 21 or a pore forming agent for adjusting the bulk density of the first active material molded body 51, however, when such an organic material remains after firing, it affects the charge conduction property, and therefore, it is preferred to reliably burn out the organic material by firing. In other words, it is desired to form the first active material molded body 51 without including an organic material such as a binder or a pore forming agent.

Subsequently, the electrolyte mixture 57 obtained in Step S3 is brought into contact with the first active material molded body 51 and impregnated thereinto, and then a heat treatment is performed to cause a reaction of the electrolyte mixture 57, whereby the electrolyte 29 and the electrolyte layer 15 are formed. By doing this, the electrolyte 29 and the electrolyte layer 15 are formed at the surface including the inside of the plurality of pores of the first active material molded body 51 (active material portion 27), whereby the positive electrode 13 and the electrolyte layer 15 are obtained.

First, the electrolyte mixture 57 and the first active material molded body 51 (active material portion 27) are brought into contact with each other, whereby the electrolyte mixture 57 is impregnated into the first active material molded body 51. Specifically, as shown in FIG. 8, the first active material molded body 51 is placed on a substrate 69. The substrate 69 is, for example, made of magnesium oxide.

Next, with reference to FIG. 8, a step of applying the electrolyte mixture 57 to the first active material molded body 51 will be described. FIG. 8 is a view illustrating the application of the electrolyte mixture 57 to the first active material molded body 51. For the first active material molded body 51, the electrolyte mixture 57 is applied to the surface including the inside of the pores of the first active material molded body 51 using a micropipette 71 or the like. At this time, the application amount of the electrolyte mixture 57 is adjusted so that the bulk density of the first positive electrode molded body (positive electrode 13) to be produced becomes approximately about 75% or more and 85% or less. In other words, the application amount of the electrolyte mixture 57 is adjusted so that about half the volume of the voids (pores) of the first active material molded body 51 is filled with the electrolyte 29. The bulk density of the first positive electrode molded body can be obtained in the same manner as the bulk density of the active material portion 27 described above.

As the method for applying the electrolyte mixture 57, other than dropping using the micropipette 71, for example, a method such as immersion, spraying, penetration by capillary phenomenon, or spin coating can be used, and these methods may be performed in combination. The electrolyte mixture 57 has fluidity, and therefore also easily reaches the inside of the pores of the first active material molded body 51 by capillary phenomenon. The electrolyte mixture 57 is applied so as to wet and spread on the entire surface including the inside of the pores of the first active material molded body 51.

Here, the electrolyte mixture 57 may be excessively applied to one face of the first active material molded body 51. By performing the below-mentioned heating treatment in this state, the first active material molded body 51 is completely sunk in the electrolyte 29, and the electrolyte layer 15 is formed.

Subsequently, the electrolyte mixture 57 impregnated into the first active material molded body 51 is subjected to a heat treatment. The heat treatment includes a fifth heat treatment (calcination) in which the heating temperature is 500° C. or higher and 650° C. or lower, and a sixth heat treatment (main firing), which is performed after the fifth heat treatment, and in which the heating temperature is 800° C. or higher and 1000° C. or lower. By the fifth heat treatment, the solvent or an organic material such as an impurity contained in the electrolyte mixture 57 is decomposed and reduced. Therefore, in the sixth heat treatment, the purity is increased, so that the reaction is accelerated, and the electrolyte 29 and the electrolyte layer 15 can be formed. Further, by setting the temperature of the heat treatment to 1000° C. or lower, the occurrence of a side reaction at the crystal grain boundary or volatilization of lithium can be suppressed. Accordingly, the lithium ion conduction property can be further improved. The heating treatment may be performed in a dry atmosphere, an oxidizing atmosphere, an inert gas atmosphere, or the like. As a method for the heat treatment, for example, the heat treatment is performed using an electric muffle furnace or the like. Thereafter, the resulting material is cooled to room temperature.

By the above step, the first positive electrode molded body (positive electrode 13) in which the first active material molded body 51 (active material portion 27) and the electrolyte 29 are combined and the electrolyte layer 15 are obtained. The obtained first positive electrode molded body has a bulk density of approximately about 75% or more and 85% or less and has a plurality of pores.

### Formation of Positive Electrode and Electrolyte Layer-b

In Step S4b, the electrolyte in the form of a calcined body and the active material are mixed, whereby the positive electrode 13 and the electrolyte layer 15 are formed.

An electrolyte calcined body is prepared from the electrolyte mixture 57 obtained in Step S3. Specifically, the electrolyte mixture 57 is subjected to a seventh heat treatment so as to perform removal of the solvent by volatilization and removal of the organic components by combustion or thermal decomposition, whereby a solid material of an electrolyte calcined body is obtained. The heating temperature of the seventh heat treatment is set to 500° C. or higher and 650° C. or lower. Subsequently, the obtained solid material of the electrolyte calcined body is ground and mixed, whereby the electrolyte calcined body in a powder form is prepared.

Subsequently, the electrolyte calcined body and the active material particles 21 obtained in Step S2 are mixed, whereby a mixed body is prepared. Predetermined amounts of the electrolyte calcined body and the active material particles 21 are weighed, for example, 0.0550 g of the electrolyte calcined body and 0.0450 g of the active material particles 21 are weighed, and sufficiently stirred and mixed, whereby a mixed body is prepared.

Subsequently, the positive electrode 13 in which the active material particles 21 and the electrolyte 29 are combined and the electrolyte layer 15 are formed. Specifically, by using a molding die, the mixed body is compression molded. For example, the mixed body is pressed at a pressure of 1019 MPa for 2 minutes using a molding die, whereby a disk-shaped molded material (diameter: 10 mm, effective diameter: 8 mm, thickness: 350 μm) of the mixed body is prepared.

Thereafter, the disk-shaped molded material is placed on a substrate or the like and is subjected to an eighth heat treatment. The heating temperature of the eighth heat treatment is set to 800° C. or higher and 1000° C. or lower, and sintering of the particles of the active material particles 21 and formation of the electrolyte 29 and the electrolyte layer 15 are promoted. The heat treatment time of the eighth heat treatment is preferably set to, for example, 5 minutes or more and 36 hours or less, and is more preferably 4 hours or more and 14 hours or less.

By doing this, a second active material molded body (active material portion 27) is formed from the active material particles 21, whereby an electron transfer pathway is formed, and also the positive electrode 13 in which the second active material molded body (active material portion 27) and the electrolyte 29 are combined and the electrolyte layer 15 are formed.

In the production of the lithium battery 1 according to this embodiment by the production method of this step, the positive electrode 13 is directly formed from the electrolyte calcined body that is the forming material of the electrolyte 29 and the active material particles 21, and therefore, an effect that the production step can be simplified such that it is only necessary to perform the heating treatment at 800° C. or higher once, and so on is exhibited.

In Step S4a (Formation of Positive Electrode and Electrolyte Layer-a) and Step S4b (Formation of Positive Electrode and Electrolyte Layer-b), the method for forming the electrolyte 29 and the electrolyte layer 15 by a liquid phase method using the electrolyte mixture 57 is described, however, the method is not limited thereto. For example, the positive electrode 13 and the electrolyte layer 15 may be obtained by filling the first active material molded body 51 (active material portion 27) with a melt of the electrolyte 29 and the electrolyte layer 15 so as to form the electrolyte 29 and the electrolyte layer 15.

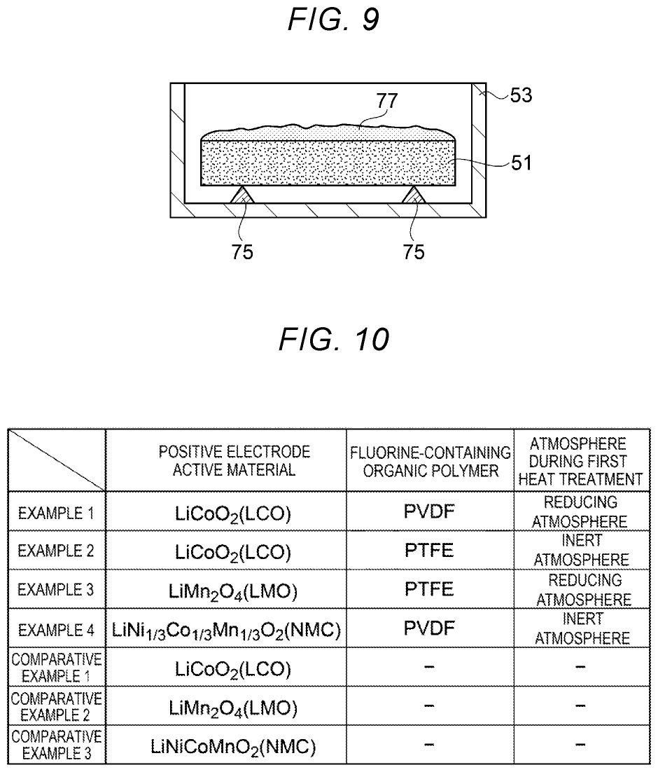

In this case, as the electrolyte 29 and the electrolyte layer 15, an electrolyte having a lower melting point than the melting point of the active material particles 21 (active material portion 27) is preferably used. For example, Li₂₊ₓC₁₋ₓBₓO₃ (hereinafter referred to as LCBO) can be used. FIG. 9 is a view showing molding of the electrolyte and the electrolyte layer composed of LCBO. First, as shown in FIG. 9, the first active material molded body 51 is placed in a crucible 53 through a support 75. Subsequently, a predetermined amount of a powder 77 of LCBO is weighed and evenly placed over the upper face of the first active material molded body 51. Since the melting point of LCBO is 700° C., the crucible 53 is heated to approximately 800° C. in an atmosphere containing carbon dioxide (CO₂) gas so as to melt the powder 77 of LCBO on the first active material molded body 51. The melt of the powder 77 partially penetrates into the porous first active material molded body 51. Thereafter, the crucible 53 is cooled to room temperature so as to solidify the melt penetrating into the first active material molded body 51. By doing this, the electrolyte 29 is partially filled in voids inside the active material portion 27, and also the electrolyte layer 15 covering the upper face of the first active material molded body 51 is formed. When the melt of LCBO is solidified, the electrolyte 29 and the electrolyte layer 15 composed of amorphous LCBO are obtained.

Since LCBO that is the electrolyte is melted in a carbon dioxide (CO₂) gas atmosphere, even if the crucible 53 is heated to 800° C., it is possible to prevent carbon (C) from coming out of LCBO resulting in changing the composition.

Since the amorphous electrolyte 29 is partially filled in voids in the first active material molded body 51, a contact area between the first active material molded body 51 (active material portion 27) and the electrolyte 29 is substantially increased, and the lithium ion conduction property (ion conductivity) is improved.

Further, in Step S4a (Formation of Positive Electrode and Electrolyte Layer-a) and Step S4b (Formation of Positive Electrode and Electrolyte Layer-b), the electrolyte 29 and the electrolyte layer 15 are formed simultaneously, however, the method is not limited thereto. For example, in the above-mentioned method, after the positive electrode 13 is formed, the electrolyte layer 15 may be formed in a separate step.

### Formation of Negative Electrode

In Step S5, the negative electrode 17 is formed at the one face 15a side of the electrolyte layer 15. As a method for forming the negative electrode 17, other than a solution process such as a so-called sol-gel method or an organometallic thermal decomposition method involving a hydrolysis reaction or the like of an organometallic compound, a CVD method using an appropriate metal compound and an appropriate gas atmosphere, an ALD method, a green sheet method or a screen printing method using a slurry of negative electrode active material particles, an aerosol deposition method, a sputtering method using an appropriate target and an appropriate gas atmosphere, a PLD method, a vacuum vapor deposition method, plating, thermal spraying, or the like can be used. Further, as a forming material of the negative electrode 17, the above-mentioned negative electrode active material can be adopted, and in this embodiment, metallic lithium (Li) is used. Specifically, a portion other than a region where the negative electrode 17 is formed is masked, and metallic lithium is deposited on the electrolyte layer 15 by a sputtering method, a vacuum vapor deposition method, or the like, whereby the negative electrode 17 having a film thickness of, for example, 50 nm or more and 100 μm or less is formed.

### Formation of Current Collector

In Step S6, first, a face (lower face) opposed to a face where the electrolyte layer 15 is formed of the positive electrode 13 is polished. At this time, by a polishing process, the active material portion 27 is reliably exposed to form the front face 13a. By doing this, electrical coupling between the active material portion 27 and the first current collector 11 to be formed thereafter can be ensured. When the active material portion 27 is sufficiently exposed at the lower face side of the positive electrode 13 in the above-mentioned step, this polishing process may be omitted.

Subsequently, the first current collector 11 is formed at the front face 13a. Examples of a method for forming the first current collector 11 include a method in which an appropriate adhesive layer is separately provided to adhere the first current collector 11, a gas phase deposition method such as a PVD method, a CVD method, a PLD method, an ALD method, and an aerosol deposition method, and a wet method such as a sol-gel method, an organometallic thermal decomposition method, and plating, and an appropriate method can be used according to the reactivity with the face where the first current collector 11 is formed, an electrical conduction property desired for the electrical circuit, and the design of the electrical circuit. Further, as a forming material of the first current collector 11, the above-mentioned forming material can be adopted. For example, in the front face 13a of the active material portion 27 exposed by polishing, a portion other than a region where the current collector 11 is formed is masked, and copper (Cu) is deposited to a film thickness of about 5 μm or less by, for example, a sputtering method, a vacuum vapor deposition method, or the like, whereby the first current collector 11 is formed. By doing this, the lithium battery 1 is completed. In this embodiment, it is described that the formation of the first current collector 11 and the second current collector is performed after the formation of the positive electrode 13 and the negative electrode 17, but may be performed before the formation of the positive electrode 13 and the negative electrode 17.

As described above, by the active material portion 27 (active material), the method for producing the active material portion 27 (active material), the positive electrode 13 (electrode assembly) and the lithium battery 1 according to the above-mentioned embodiment, the following effects can be obtained.

According to the active material (active material portion 27), a composite metal oxide is included, and therefore, as compared with a case where the active material portion 27 is constituted only by a lithium composite metal oxide, the interface resistance is reduced, and this can contribute to the improvement of the battery characteristics (charge-discharge characteristics). Further, the composite metal oxide is also formed at the surfaces of the active material particles 21 forming voids in the active material portion 27 (positive electrode 13), that is, inside the active material portion 27, and therefore, the interface resistance is reduced, and this can contribute to the improvement of the battery characteristics (charge-discharge characteristics).

In the active material portion 27, when the weight ratio of the first active material 23 and the second active material 25 becomes as described above, the interface resistance is reduced, and this can contribute to the improvement of the battery characteristics.

When the active material portion 27 includes any of LiCoOF, LiNiOF, LiMn₂O₃F, LiMn₂O₂F, and Li(Mn_{1-x-y}Co_{y})OF, the interface resistance is reduced, and this can contribute to the improvement of the battery characteristics.

According to the method for producing the active material portion 27, the active material portion 27 including a composite metal oxide is formed, and it becomes possible to produce the active material portion 27 capable of contributing to the improvement of the battery characteristics.

In the method for producing the active material (active material portion 27), when PVDF is used as the fluorinated organic polymer, the active material portion 27 including a composite metal oxide can be efficiently produced. Further, the active material portion 27 including a composite metal oxide with few impurities can be produced. In addition, the active material portion 27 including a composite metal oxide can be produced at low cost as compared with a case where PTFE is selected. Further, by setting the mixing ratio of a lithium composite metal oxide and PVDF to the above-mentioned molar ratio, the active material portion 27 including a composite metal oxide can be efficiently produced.

In the method for producing the active material portion 27, when PTFE is used as the fluorinated organic polymer, the active material portion 27 including a composite metal oxide can be efficiently produced. Further, the active material portion 27 including a composite metal oxide with few impurities can be produced. In addition, the active material portion 27 including a composite metal oxide can be more efficiently produced as compared with a case where PVDF is selected. Further, by setting the mixing ratio of a lithium composite metal oxide and PTFE to the above-mentioned molar ratio, the active material portion 27 including a composite metal oxide can be efficiently produced.

According to the electrode assembly (positive electrode 13), the active material portion 27 including a composite metal oxide is included, and therefore, as compared with a case where the active material portion 27 is constituted only by a lithium composite metal oxide, the interface resistance is reduced, and this can contribute to the improvement of the battery characteristics (charge-discharge characteristics). Further, the second active material 25 is also formed at the surfaces of the active material particles 21 forming voids in the active material portion 27 (positive electrode 13), that is, inside the active material portion 27, and therefore, the interface resistance is reduced, and this can contribute to the improvement of the battery characteristics (charge-discharge characteristics).

According to the lithium battery 1, the active material portion 27 including a composite metal oxide is included, and therefore, as compared with a case where the active material portion 27 is constituted only by a lithium composite metal oxide, the interface resistance is reduced, and this can contribute to the improvement of the battery characteristics (charge-discharge characteristics). Further, the composite metal oxide is also formed at the surfaces of the active material particles 21 forming voids in the active material portion 27 (positive electrode 13), that is, inside the active material portion 27, and therefore, the interface resistance is reduced, and this can contribute to the improvement of the battery characteristics (charge-discharge characteristics).

Next, the effects of the above-mentioned embodiment will be more specifically described by showing Examples and Comparative Examples as the active material (active material portion 27) of the above-mentioned embodiment. FIG. 10 is a table showing the compositions of the active material portions 27 according to Examples and Comparative Examples. The weight measurement in the following experiment was performed up to 0.1 mg units using an analytical balance ME204T (Mettler Toledo International, Inc.).

### Examples and Comparative Examples of Active Material Portion Molding of Active Material Portion

In Examples and Comparative Examples of the active material portion, the positive electrode active materials shown in FIG. 10 were molded. In FIG. 10 and the description below, PVDF denotes polyvinylidene fluoride —(C₂H₂F₂)ₙ— and has a unit formula weight of 64.03. PTFE denotes polytetrafluoroethylene —(C₂H₂)ₙ— and has a unit formula weight of 100.01. LCO denotes LiCoO₂ and has a formula weight of 97.872. LMO denotes LiMn₂O₄ and has a formula weight of 180.813. NMC denotes LiNiCoMnO₂ and has a formula weight of 211.503.

### Molding of Active Material Portion Using LCO Fluorinated Using PVDF in Example 1

In Example 1, the active material portion is molded using LCO fluorinated using PVDF. First, in a 30-mL reagent bottle made of Pyrex (trademark of Corning Incorporated), a magnetic stirrer bar, 2.000 g of LCO, 1.308 g of PVDF, and 10 mL of n-hexane are weighed, and the reagent bottle is covered with a lid. The reagent bottle after weighing is performed is placed on a magnetic stirrer with a hot plate function, and stirring is performed at 450 rpm for 1 hour at room temperature, whereby a mixture is obtained. The temperature of the magnetic stirrer with a hot plate function is increased to 50° C., and the lid of the reagent bottle containing the mixture sample is taken off so as to volatilize n-hexane. The mixture is taken out from the reagent bottle and transferred to an agate mortar and then, ground and mixed, and the remaining n-hexane is volatilized. In a 30-mL capacity crucible made of magnesium oxide, the mixture obtained by volatilizingn-hexane is placed, the crucible is covered with a lid made of magnesium oxide, and the temperature is increased from room temperature at a temperature increasing rate of 4° C./min in a reducing atmosphere (argon: 97 vol %+hydrogen: 3 vol %), and after the temperature reaches 400° C., firing is performed at 400° C. for 20 hours. After the temperature is gradually decreased to room temperature, the temperature is increased from room temperature at a temperature increasing rate of 4° C./min in the atmosphere, and after the temperature reaches 400° C., firing is performed at 400° C. for 20 hours. Thereafter, the temperature is gradually decreased to room temperature, and then, the temperature is increased from room temperature at a temperature increasing rate of 1° C./min in the atmosphere, and after the temperature reaches 1000° C., firing is performed at 1000° C. for 8 hours, whereby a product is obtained.

When LCO before fluorination was observed using the below-mentioned SEM-EDS or the like, Co:O=1:2 (atomic ratio), and fluorine was not confirmed. However, it was confirmed that in the fluorinated LCO, Co:O:F=1:2:0.36 (atomic ratio), that is, O:F=1.69:0.31 (atomic ratio).

### Molding of Active Material Portion Using LCO Fluorinated Using PTFE in Example 2

In Example 2, the active material portion is molded using LCO fluorinated using PTFE. First, in a 30-mL reagent bottle made of Pyrex (trademark of Corning Incorporated), a magnetic stirrer bar, 2.000 g of LCO, 1.022 g of PTFE, and 10 mL of n-hexane are weighed, and the reagent bottle is covered with a lid. The reagent bottle after weighing is performed is placed on a magnetic stirrer with a hot plate function, and stirring is performed at 450 rpm for 1 hour at room temperature, whereby a mixture is obtained. The temperature of the magnetic stirrer with a hot plate function is increased to 50° C., and the lid of the reagent bottle containing the mixture sample is taken off so as to volatilize n-hexane. The mixture is taken out from the reagent bottle and transferred to an agate mortar and then, ground and mixed, and the remaining n-hexane is volatilized. In a 30-mL capacity crucible made of magnesium oxide, the mixture obtained by volatilizingn-hexane is placed, the crucible is covered with a lid made of magnesium oxide, and the temperature is increased from room temperature at a temperature increasing rate of 4° C./min in an inert atmosphere (argon), and after the temperature reaches 400° C., firing is performed at 400° C. for 20 hours. After the temperature is gradually decreased to room temperature, the temperature is increased from room temperature at a temperature increasing rate of 4° C./min in the atmosphere, and after the temperature reaches 400° C., firing is performed at 400° C. for 20 hours. Thereafter, the temperature is gradually decreased to room temperature, and then, the temperature is increased from room temperature at a temperature increasing rate of 1° C./min in the atmosphere, and after the temperature reaches 1000° C., firing is performed at 1000° C. for 8 hours, whereby a product is obtained.

When LCO before fluorination was observed using the below-mentioned SEM-EDS or the like in the same manner as in Example 1, Co:O=1:2 (atomic ratio), and fluorine was not confirmed. However, it was confirmed that in the fluorinated LCO, Co:O:F=1:2:0.38 (atomic ratio), that is, O:F=1.68:0.32 (atomic ratio).

### Molding of Active Material Portion Using LMO Fluorinated Using PTFE in Example 3

In Example 3, the active material portion is molded using LMO fluorinated using PTFE. First, in a 30-mL reagent bottle made of Pyrex (trademark of Corning Incorporated), a magnetic stirrer bar, 2.000 g of LMO, 0.553 g of PTFE, and 10 mL of n-hexane are weighed, and the reagent bottle is covered with a lid. The reagent bottle after weighing is performed is placed on a magnetic stirrer with a hot plate function, and stirring is performed at 450 rpm for 1 hour at room temperature, whereby a mixture is obtained. The temperature of the magnetic stirrer with a hot plate function is increased to 50° C., and the lid of the reagent bottle containing the mixture sample is taken off so as to volatilize n-hexane. The mixture is taken out from the reagent bottle and transferred to an agate mortar and then, ground and mixed, and the remaining n-hexane is volatilized. In a 30-mL capacity crucible made of magnesium oxide, the mixture obtained by volatilizingn-hexane is placed, the crucible is covered with a lid made of magnesium oxide, and the temperature is increased from room temperature at a temperature increasing rate of 4° C./min in a reducing atmosphere (argon: 97 vol %+hydrogen: 3 vol %), and after the temperature reaches 400° C., firing is performed at 400° C. for 20 hours. After the temperature is gradually decreased to room temperature, the temperature is increased from room temperature at a temperature increasing rate of 4° C./min in the atmosphere, and after the temperature reaches 400° C., firing is performed at 400° C. for 20 hours. Thereafter, the temperature is gradually decreased to room temperature, and then, the temperature is increased from room temperature at a temperature increasing rate of 1° C./min in the atmosphere, and after the temperature reaches 900° C., firing is performed at 900° C. for 8 hours, whereby a product is obtained.

When LMO before fluorination was observed using the below-mentioned SEM-EDS or the like in the same manner as in Examples 1 and 2, Mn:O=1:2 (atomic ratio), and fluorine was not confirmed. However, it was confirmed that in the fluorinated LMO, Mn:O:F=1:2:0.18 (atomic ratio), that is, O:F=1.84:0.16 (atomic ratio).

### Molding of Active Material Portion Using NMC Fluorinated Using PVDF in Example 4

In Example 4, the active material portion is molded using NMC fluorinated using PVDF. First, in a 30-mL reagent bottle made of Pyrex (trademark of Corning Incorporated), a magnetic stirrer bar, 2.000 g of NMC, 0.605 g of PVDF, and 10 mL of n-hexane are weighed, and the reagent bottle is covered with a lid. The reagent bottle after weighing is performed is placed on a magnetic stirrer with a hot plate function, and stirring is performed at 450 rpm for 1 hour at room temperature, whereby a mixture is obtained. The temperature of the magnetic stirrer with a hot plate function is increased to 50° C., and the lid of the reagent bottle containing the mixture sample is taken off so as to volatilize n-hexane. The mixture is taken out from the reagent bottle and transferred to an agate mortar and then, ground and mixed, and the remaining n-hexane is volatilized. In a 30-mL capacity crucible made of magnesium oxide, the mixture obtained by volatilizing n-hexane is placed, the crucible is covered with a lid made of magnesium oxide, and the temperature is increased from room temperature at a temperature increasing rate of 4° C./min in an inert atmosphere (argon), and after the temperature reaches 400° C., firing is performed at 400° C. for 20 hours. After the temperature is gradually decreased to room temperature, the temperature is increased from room temperature at a temperature increasing rate of 4° C./min in the atmosphere, and after the temperature reaches 400° C., firing is performed at 400° C. for 20 hours. Thereafter, the temperature is gradually decreased to room temperature, and then, the temperature is increased from room temperature at a temperature increasing rate of 1° C./min in the atmosphere, and after the temperature reaches 900° C., firing is performed at 900° C. for 8 hours, whereby a product is obtained.

When NMC before fluorination was observed using the below-mentioned SEM-EDS or the like in the same manner as in Examples 1 to 3, Ni:Mn:Co:O=1:1:1:6 (atomic ratio), and fluorine was not confirmed. However, it was confirmed that in the fluorinated NMC, Ni:Mn:Co:O:F=1:1:1:6:1.17 (atomic ratio), that is, O:F=1.67:0.33 (atomic ratio).

### Molding of Active Material Portion Using Non-Fluorinated LCO in Comparative Example 1

In Comparative Example 1, the active material portion is molded using the active material that is not fluorinated. Therefore, the fluorination step is omitted. In Comparative Example 1, the active material shown in FIG. 10 is used, and the temperature is increased from room temperature at a temperature increasing rate of 1° C./min in the atmosphere, and after the temperature reaches 1000° C., firing is performed at 1000° C. for 8 hours, whereby a product is obtained.

### Molding of Active Material Portion Using Non-Fluorinated LMO in Comparative Example 2

In Comparative Example 2, the active material portion is molded using the active material that is not fluorinated. Therefore, the fluorination step is omitted. In Comparative Example 2, the active material shown in FIG. 10 is used, and the temperature is increased from room temperature at a temperature increasing rate of 1° C./min in the atmosphere, and after the temperature reaches 900° C., firing is performed at 900° C. for 8 hours, whereby a product is obtained.

### Molding of Active Material Portion Using Non-Fluorinated NMC in Comparative Example 3

In Comparative Example 3, the active material portion is molded using the active material that is not fluorinated. Therefore, the fluorination step is omitted. In Comparative Example 3, the active material shown in FIG. 10 is used, and the temperature is increased from room temperature at a temperature increasing rate of 1° C./min in the atmosphere, and after the temperature reaches 900° C., firing is performed at 900° C. for 8 hours, whereby a product is obtained.

### Evaluation of Active Material Portion

### XRD Analysis

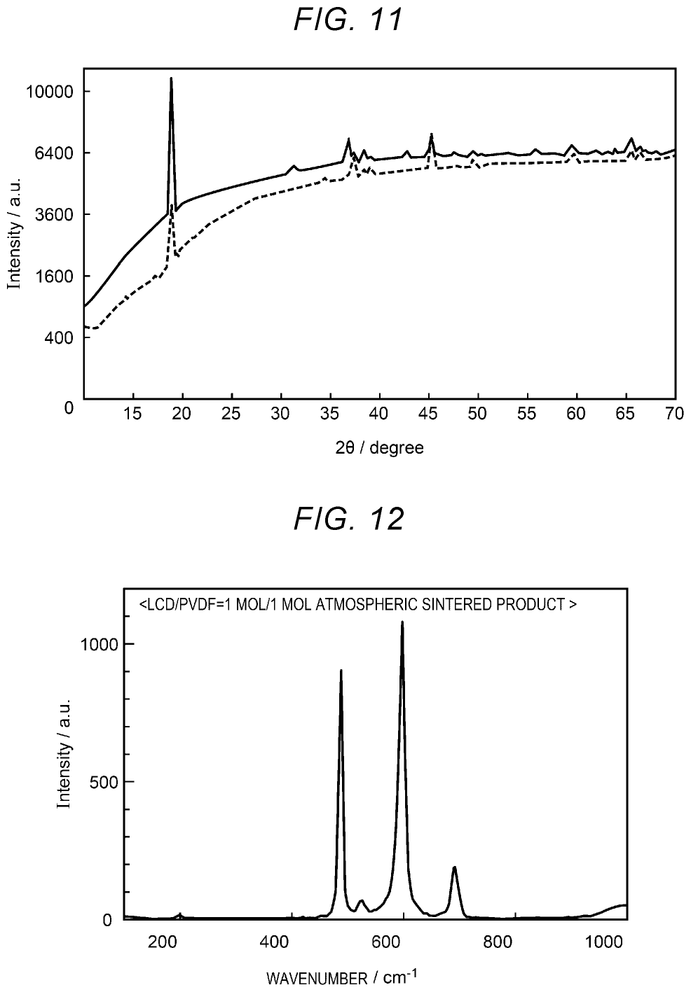

With respect to the products of the active materials of Examples and Comparative Examples, X-ray diffraction (XRD) analysis was performed, and the crystal structures were analyzed. Specifically, byproduction of impurities or the like was examined using an X-ray diffractometer MRD (Philips). As the X-ray, a Cu-Kα beam is used, and the wavelength (α) is set as follows: α=1.5418 Å. As representative examples, the XRD charts of Example 1 and Comparative Example 1 are shown in FIG. 11.

The examination results of byproduction of impurities in the active material portion or the like will be described with reference to FIG. 11. FIG. 11 is a view showing the XRD charts of Example 1 and Comparative Example 1. The solid line in FIG. 11 indicates the XRD chart of Example 1 (the active material portion using LCO fluorinated using PVDF), and the broken line in FIG. 11 indicates the XRD chart of Comparative Example 1 (the active material portion using non-fluorinated LCO). As shown in FIG. 11, in comparison of fluorinated LCO with non-fluorinated LCO, only diffraction peaks derived from LCO were detected, and diffraction peaks derived from impurities were not detected in any diffraction peaks. That is, it was found that the fluorinated LCO in Example 1 and the non-fluorinated LCO in Comparative Example 1 have the same crystal structure.

Similarly, XRD analysis was performed for Example 2 and Comparative Example 1, Example 3 and Comparative Example 2, and Example 4 and Comparative Example 3, and as a result, the same results as those obtained by performing XRD analysis for Example 1 and Comparative Example 1 were obtained, and it was found that the crystal structure is not changed by fluorination of the active material.

### Raman Scattering Analysis

With respect to the active material portions of Examples, Raman scattering analysis was performed. Specifically, a Raman scattering spectrum was obtained using a Raman spectrometer S-2000 (JEOL Ltd.), and the crystal system of the active material portion was confirmed. As a representative example, the Raman scattering spectrum of Example 1 is shown in FIG. 12.

The crystal system of the active material portion will be described with reference to FIG. 12. FIG. 12 is a view showing the Raman scattering spectrum of Example 1. In FIG. 12, the horizontal axis represents a wavenumber, and the vertical axis represents an intensity (the intensity is higher at the upper side). As shown in FIG. 12, in Example 1, peaks at around 470 cm⁻¹ and at around 600 cm are intensified in the same manner as non-fluorinated LCO (not shown) and detected. This shows that fluorinated LCO has the same crystal system as non-fluorinated LCO.

Similarly, it was also confirmed that the crystal system is not changed by fluorination in Examples 2 to 4.

### SEM-EDS Analysis

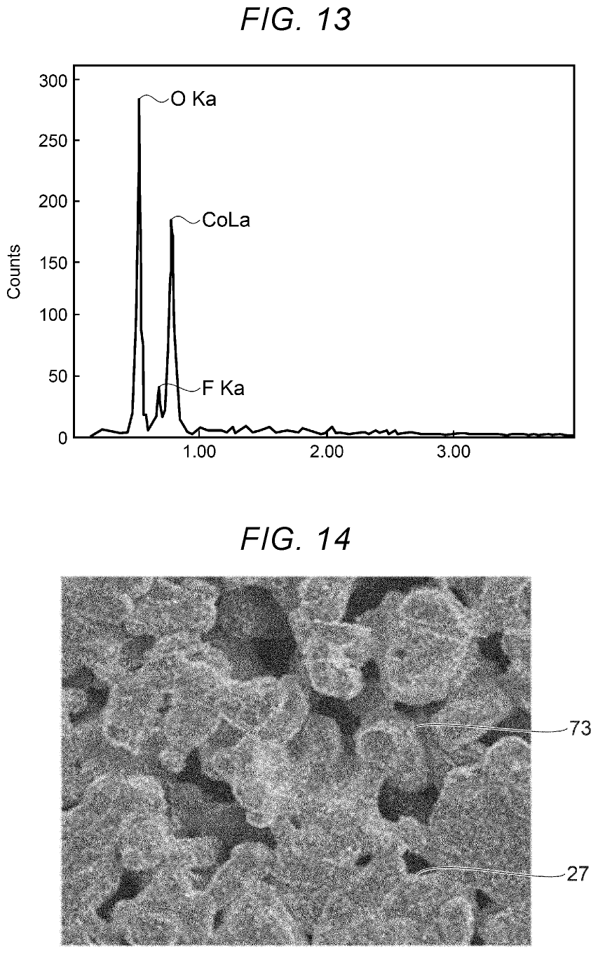

With respect to the active material portion of Example, SEM-EDS analysis was performed. Specifically, the SEM-EDS analysis was performed using a scanning electron microscope with EBSP, X30SFEG/EBSP (manufactured by FEI Company Japan Ltd.), and the fluorinated state of the active material portion was confirmed. As the X-ray, a Mg-Kα beam (soft X-ray) is used, and the wavelength (α) is set as follows: α=9.8900 Å. As representative examples, the SEM-EDS spectrum of Example 1 is shown in FIG. 13, and the SEM-EDS mapping of Example 1 is shown in FIG. 14.

The fluorinated state of the active material portion will be described with reference to FIGS. 13 and 14. FIG. 13 is a view showing the SEM-EDS spectrum of the active material portion of Example 1. As shown in FIG. 13, it is found that oxygen (O), fluorine (F), and cobalt (Co) are present in the active material portion of Example 1. That is, it was confirmed that LCO of Example 1 is fluorinated. Further, FIG. 14 is a view showing the SEM-EDS mapping of the active material portion of Example 1. As shown in FIG. 14, it is found that fluorine (F) 73 in the second active material 25 that is fluorinated LCO is evenly present in the active material portion 27 that is an LCO particle.

Similarly, it was also confirmed that the active material portion is evenly fluorinated in Examples 2 to 4.

From the above-mentioned XRD analysis, Raman scattering analysis, and SEM-EDS analysis, it was found that a fluorination treatment is evenly carried out without changing the crystal structure and the crystal system in Examples 1 to 4.

### Electrochemical Impedance Measurement

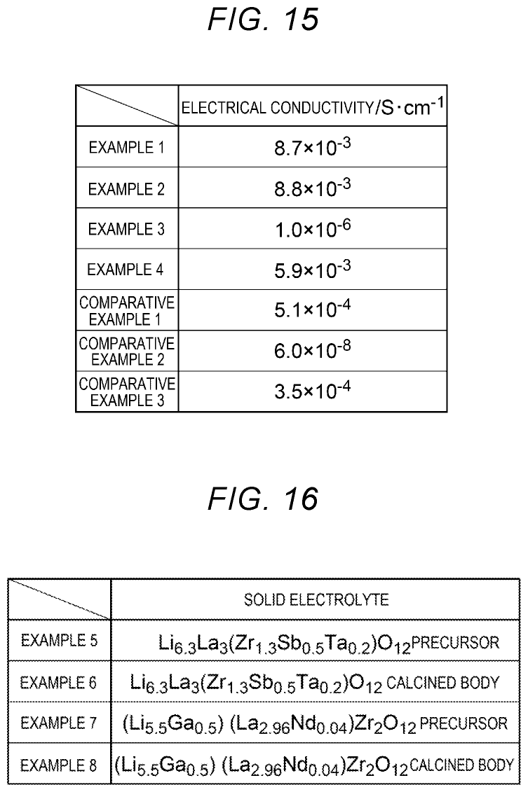

With respect to the active material portions of Examples and Comparative Examples, electrochemical impedance measurement (EIS measurement) was performed. Specifically, the measurement was performed by using an electrode with a diameter of 6.6 mm and setting the AC amplitude to 10 mV and the measurement frequency within a range of 10⁷ Hz to 10⁻¹ Hz while changing the frequency from the high frequency side to the low frequency side. In the measurement, a frequency response analyzer 1260 (Solartron, Inc.) was used. The measurement results are shown in FIG. 15.

FIG. 15 is a table showing the evaluation results of electrical conductivities of the active material portions of Examples and Comparative Examples. As shown in FIG. 15, when comparing Example 1 with Comparative Example 1, Example 2 with Comparative Example 1, Example 3 with Comparative Example 2, and Example 4 with Comparative Example 3, respectively, it was found that the electrical conductivity of the fluorinated active material portion is improved as compared with that of the non-fluorinated active material portion. That is, it was found that when a fluorinated active material is used, the charge-discharge characteristics of a battery are improved.

Next, the effects of the above-mentioned embodiment will be more specifically described by showing Examples and Comparative Examples as the positive electrode (electrode assembly) of the above-mentioned embodiment. The weight measurement in the following experiment was performed up to 0.1 mg units using an analytical balance ME204T (Mettler Toledo International, Inc.).

### Examples and Comparative Examples of Positive Electrode Preparation of Metal Compound Solutions

First, by using a lithium compound, a lanthanum compound, a neodymium compound, a zirconium compound, a gallium compound, an antimony compound, a tantalum compound, and a solvent, the following metal compound solutions were prepared as metal element sources containing the metal compounds, respectively.

### 2-Butoxyethanol Solution of 1 Mol/Kg Lithium Nitrate

In a 30-g reagent bottle made of Pyrex (trademark of Corning Incorporated) equipped with a magnetic stirrer bar, 1.3789 g of lithium nitrate with a purity of 99.995% (Kanto Chemical Co., Inc., 4N5) and 18.6211 g of 2-butoxyethanol (ethylene glycol monobutyl ether) (Kanto Chemical Co., Inc., Cica Special Grade) were weighed. Then, the bottle was placed on a magnetic stirrer with a hot plate function, and lithium nitrate was completely dissolved in 2-butoxyethanol while stirring at 190° C. for 1 hour. The resulting solution was gradually cooled to room temperature (about 20° C.), whereby a 2-butoxyethanol solution of 1 mol/kg lithium nitrate was obtained. The purity of lithium nitrate can be measured using an ion chromatography-mass spectrometer.

### 2-Butoxyethanol Solution of 1 Mol/Kg Lanthanum Nitrate Hexahydrate

In a 30-g reagent bottle made of Pyrex equipped with a magnetic stirrer bar, 8.6608 g of lanthanum nitrate hexahydrate (Kanto Chemical Co., Inc., 4N) and 11.3392 g of 2-butoxyethanol were weighed. Then, the bottle was placed on a magnetic stirrer with a hot plate function, and lanthanum nitrate hexahydrate was completely dissolved in 2-butoxyethanol while stirring at 140° C. for 30 minutes. The resulting solution was gradually cooled to room temperature, whereby a 2-butoxyethanol solution of 1 mol/kg lanthanum nitrate hexahydrate was obtained.

Ethyl Alcohol Solution of 1 Mol/Kg Gallium Nitrate n-Hydrate

In a 20-g reagent bottle made of Pyrex equipped with a magnetic stirrer bar, 3.5470 g of gallium nitrate n-hydrate (n=5.5, Kojundo Chemical Laboratory Co., Ltd., 5N) and 6.4530 g of ethyl alcohol were weighed. Then, the bottle was placed on a magnetic stirrer with a hot plate function, and gallium nitrate n-hydrate (n=5.5) was completely dissolved in ethyl alcohol while stirring at 90° C. for 1 hour. The resulting solution was gradually cooled to room temperature, whereby an ethyl alcohol solution of 1 mol/kg gallium nitrate n-hydrate (n=5.5) was obtained. The hydration number n of the used gallium nitrate n-hydrate was 5.5 from the result of mass loss by a combustion experiment.

### 2-Butoxyethanol Solution of 1 Mol/Kg Neodymium Nitrate Hydrate

In a 20-g reagent bottle made of Pyrex equipped with a magnetic stirrer bar, 4.2034 g of neodymium nitrate hydrate (n=5, Kojundo Chemical Laboratory Co., Ltd., 4N) and 5.7966 g of 2-butoxyethanol were weighed. Then, the bottle was placed on a magnetic stirrer with a hot plate function, and neodymium nitrate hydrate (n=5) was completely dissolved in 2-butoxyethanol while stirring at 140° C. for 30 minutes. The resulting solution was gradually cooled to room temperature, whereby a 2-butoxyethanol solution of 1 mol/kg neodymium nitrate hydrate (n=5) was obtained. The hydration number n of the used neodymium nitrate hydrate was 5.0 from the result of mass loss by a combustion experiment.

### Butanol Solution of 1 Mol/Kg Zirconium Tetra-n-Butoxide

In a 20-g reagent bottle made of Pyrex equipped with a magnetic stirrer bar, 3.8368 g of zirconium tetra-n-butoxide (Wako Pure Chemical Industries, Ltd.) and 6.1632 g of butanol (n-butanol) were weighed. Then, the bottle was placed on a magnetic stirrer, and zirconium tetra-n-butoxide was completely dissolved in butanol while stirring at room temperature for 30 minutes, whereby a butanol solution of 1 mol/kg zirconium tetra-n-butoxide was obtained.

### 2-Butoxyethanol Solution of 1 Mol/Kg Antimony Tri-n-Butoxide

In a 20-g reagent bottle made of Pyrex equipped with a magnetic stirrer bar, 3.4110 g of antimony tri-n-butoxide (Wako Pure Chemical Industries, Ltd.) and 6.5890 g of 2-butoxyethanol were weighed. Then, the bottle was placed on a magnetic stirrer, and antimony tri-n-butoxide was completely dissolved in 2-butoxyethanol while stirring at room temperature for 30 minutes, whereby a 2-butoxyethanol solution of 1 mol/kg antimony tri-n-butoxide was obtained.

### 2-Butoxyethanol Solution of 1 Mol/Kg Tantalum Penta-n-Butoxide

In a 20-g reagent bottle made of Pyrex equipped with a magnetic stirrer bar, 5.4640 g of tantalum penta-n-butoxide (Kojundo Chemical Lab. Co., Ltd., 5N) and 4.5360 g of 2-butoxyethanol were weighed. Then, the bottle was placed on a magnetic stirrer, and tantalum penta-n-butoxide was completely dissolved in 2-butoxyethanol while stirring at room temperature for 30 minutes, whereby a 2-butoxyethanol solution of 1 mol/kg tantalum penta-n-butoxide was obtained.

### Preparation and Calcination of Precursor Solution of Electrolyte

Subsequently, precursor solutions of electrolytes were prepared according to the compositions of the electrolytes shown in FIG. 16. FIG. 16 is a table showing the compositions of the electrolytes of Examples. The preparation was performed by setting the amount of lithium (Li) to 1.2 times the stoichiometric ratio (in consideration of the volatilization amount as Li₂CO₃ during firing at 900° C.) and the amounts of the other metal sources equal to the stoichiometric ratios.

### Precursor Solution of Li_{6.3}La₃(Zr_{1.3}Sb_{0.5}Ta_{0.2})O₁₂ of Example 5; Preparation for Main Firing at 900° C.

In Example 5, a solution containing the precursors of Li_{6.3}La₃(Zr_{1.3}Sb_{0.5}Ta_{0.2})O₁₂ was prepared. First, 7.560 g of the 2-butoxyethanol solution of 1 mol/kg lithiumnitrate, 3.000 g of the 2-butoxyethanol solution of 1 mol/kg lanthanum nitrate hexahydrate, 1.300 g of the butanol solution of 1 mol/kg zirconium tetra-n-butoxide, 0.500 g of the 2-butoxyethanol solution of 1 mol/kg antimony tri-n-butoxide, and 0.200 g of the 2-butoxyethanol solution of 1 mol/kg tantalum penta-n-butoxide were weighed in a glass beaker, and a magnetic stirrer bar was placed therein. Subsequently, stirring was performed at room temperature for 30 minutes using a magnetic stirrer, whereby the precursor solution of the electrolyte of Example 5 was prepared. In Example 5, calcination is not performed.

### 540° C.-Calcined Body of Li_{6.3}La₃(Zr_{1.3}Sb_{0.5}Ta_{0.2})O₁₂ of Example 6; Molding for Main Firing at 900° C.

In Example 6, a precursor solution of Li_{6.3}La₃(Zr_{1.3}Sb_{0.5}Ta_{0.2})O₁₂ prepared in the same manner as in Example 5 is calcined, whereby a calcined body is formed. First, the precursor solution of Example 5 is placed in a titanium dish (φ 50 mm×H 20 mm), and this dish is placed on a hot plate under dry air (DA), and the solvent is dried at 180° C. for 1 hour. Subsequently, carbohydrates are decomposed at 360° C. for 30 minutes. Finally, the residual carbohydrates are decomposed at 540° C. for 1 hour, followed by cooling to room temperature, whereby a 540° C.-calcined body is obtained.

It was confirmed that the calcined body maintains the ratio of the respective metal sources at the time of preparation of the precursor solution by ICP-AES (ICP emission spectroscopy) (Li:La:Zr:Sb:Ta=7.56:3:1.3:0.5:0.2).

### Precursor Solution of (Li_{5.5}Ga_{0.5})(La_{2.96}Nd_{0.04})Zr₂O₁₂ of Example 7; Preparation for Main Firing at 900° C.

In Example 7, a solution containing the precursors of (Li_{5.5}Ga_{0.5})(La_{2.96}Nd_{0.04})Zr₂O₁₂ was prepared. First, 6.600 g of the 2-butoxyethanol solution of 1 mol/kg lithium nitrate, 0.500 g of the ethanol solution of 1 mol/kg gallium nitrate n-hydrate, 2.960 g of the 2-butoxyethanol solution of 1 mol/kg lanthanum nitrate hexahydrate, 0.040 g of the 2-butoxyethanol solution of 1 mol/kg neodymium nitrate hydrate, and 2.000 g of the butanol solution of 1 mol/kg zirconium tetra-n-butoxide were weighed in a glass beaker, and a magnetic stirrer bar was placed therein. Subsequently, stirring was performed at room temperature for 30 minutes using a magnetic stirrer, whereby the precursor solution of the electrolyte of Example 7 was prepared. In Example 7, calcination is not performed.

### Calcined Body of (Li_{5.5}Ga_{0.5})(La_{2.96}Nd_{0.04})Zr₂O₁₂ of Example 8; Molding for Main Firing at 900° C.

In Example 8, a calcined body obtained by calcination of the precursor solution of (Li_{5.5}Ga_{0.5})(La_{2.96}Nd_{0.04})Zr₂O₁₂ prepared in Example 7 is molded. First, the precursor solution of Example 7 is placed in a titanium dish (φ 50 mm×H 20 mm), and this dish is placed on a hot plate under dry air (DA), and the solvent is dried at 180° C. for 1 hour. Subsequently, carbohydrates are decomposed at 360° C. for 30 minutes. Finally, the residual carbohydrates are decomposed at 540° C. for 1 hour, followed by cooling to room temperature, whereby a 540° C.-calcined body is obtained.

It was confirmed that the calcined body maintains the ratio of the respective metal sources at the time of preparation of the precursor solution by ICP-AES (ICP emission spectroscopy) (Li:Ga:La:Nd:Zr=6.6:0.5:2.96:0.04:2).

### Molding of Positive Electrode (Electrode Assembly) and Electrolyte Layer

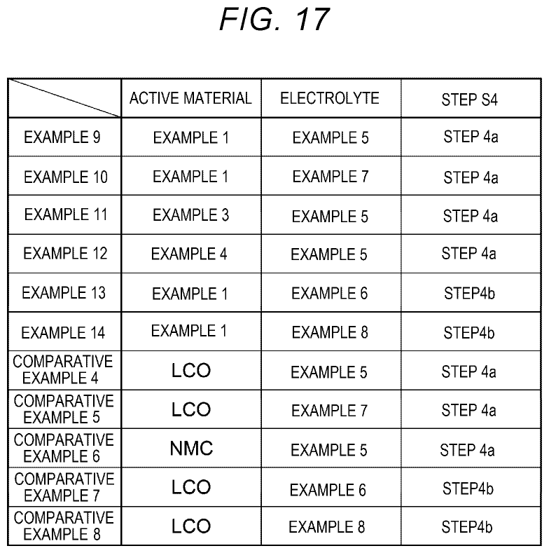

Subsequently, a positive electrode and an electrolyte layer were molded according to the compositions of the active material and the electrolyte shown in FIG. 17. FIG. 17 is a table showing the configurations of the active materials and the electrolytes of Examples and Comparative Examples.

### Molding of Positive Electrode and Electrolyte Layer Using Fluorinated LCO and Precursor Solution of Li_{6.3}La₃(Zr_{1.3}Sb_{0.5}Ta_{0.2})O₁₂ in Example 9

A positive electrode and an electrolyte layer are molded using the fluorinated LCO of Example 1 as the active material and the precursor solution of Li_{6.3}La₃(Zr_{1.3}Sb_{0.5}Ta_{0.2})O₁₂ of Example 5 as the electrolyte precursor solution. Specifically, injection of the precursor solution of Li_{6.3}La₃(Zr_{1.3}Sb_{0.5}Ta_{0.2})O₁₂ into the voids in the active material portion molded using the fluorinated LCO of Example 1 and calcination were repeatedly performed, and main firing at 900° C. for 8 hours was performed in the end, whereby the positive electrode was molded. The thickness of the positive electrode was set to about 150 μm, the thickness of the electrolyte layer was set to about 15 μm, and the effective diameter was set to about 8 mm.

### Molding of Positive Electrode Using Fluorinated LCO and Precursor Solution of (Li_{5.5}Ga_{0.5})(La_{2.96}Nd_{0.04})Zr₂O₁₂ in Example 10

A positive electrode and an electrolyte layer are molded using the fluorinated LCO of Example 1 as the active material and the precursor solution of (Li_{5.5}Ga_{0.5})(La_{2.96}Nd_{0.04})Zr₂O₁₂ of Example 7 as the electrolyte precursor solution. Specifically, injection of the precursor solution of (Li_{5.5}Ga_{0.5})(La_{2.96}Nd_{0.04})Zr₂O₁₂ into the voids in the active material portion molded using the fluorinated LCO of Example 1 and calcination were repeatedly performed, and main firing at 900° C. for 8 hours was performed in the end, whereby the positive electrode was molded. The thickness of the positive electrode was set to about 150 μm, the thickness of the electrolyte layer was set to about 15 μm, and the effective diameter was set to about 8 mm.

### Molding of Positive Electrode Using Fluorinated LMO and Precursor Solution of Li_{6.3}La₃(Zr_{1.3}Sb_{0.5}Ta_{0.2})O₁₂ in Example 11

A positive electrode and an electrolyte layer are molded using the fluorinated LMO of Example 3 as the active material and the precursor solution of Li_{6.3}La₃(Zr_{1.3}Sb_{0.5}Ta_{0.2})O₁₂ of Example 5 as the electrolyte precursor solution. Specifically, injection of the precursor solution of Li_{6.3}La₃(Zr_{1.3}Sb_{0.5}Ta_{0.2})O₁₂ into the voids in the active material portion molded using the fluorinated LMO of Example 3 and calcination were repeatedly performed, and main firing at 900° C. for 8 hours was performed in the end, whereby the positive electrode was molded. The thickness of the positive electrode was set to about 150 μm, the thickness of the electrolyte layer was set to about 15 μm, and the effective diameter was set to about 8 mm.

### Molding of Positive Electrode Using Fluorinated NMC and Precursor Solution of Li_{6.3}La₃(Zr_{1.3}Sb_{0.5}Ta_{0.2})O₁₂ in Example 12

A positive electrode and an electrolyte layer are molded using the fluorinated NMC of Example 4 as the active material and the precursor solution of Li_{6.3}La₃(Zr_{1.3}Sb_{0.5}Ta_{0.2})O₁₂ of Example 5 as the electrolyte precursor solution. Specifically, injection of the precursor solution of Li_{6.3}La₃(Zr_{1.3}Sb_{0.5}Ta_{0.2})O₁₂ into the voids in the active material portion molded using the fluorinated NMC of Example 4 and calcination were repeatedly performed, and main firing at 900° C. for 8 hours was performed in the end, whereby the positive electrode was molded. The thickness of the positive electrode was set to about 150 μm, the thickness of the electrolyte layer was set to about 15 μm, and the effective diameter was set to about 8 mm.

### Molding of Positive Electrode Using Fluorinated LCO and 540° C.-Calcined Body of Li_{6.3}La₃(Zr_{1.3}Sb_{0.5}Ta_{0.2})O₁₂ in Example 13

A positive electrode and an electrolyte layer are molded using the fluorinated LCO of Example 1 as the active material and the 540° C.-calcined body of Li_{6.3}La₃(Zr_{1.3}Sb_{0.5}Ta_{0.2})O₁₂ of Example 6 as the electrolyte calcined body. Specifically, 0.0450 g of the fluorinated LCO of Example 1 and 0.0550 g of the calcined body of Example 6 in a powder form are sufficiently stirred and mixed, whereby 0.1000 g of a mixed body is prepared.

The mixed body is compression molded using a molding die. For example, by using a molding die (a die with an exhaust port having an inner diameter of 10 mm), the mixed body is pressed at a pressure of 1019 MPa for 2 minutes, whereby a disk-shaped molded material (diameter: 10 mm, effective diameter: 8 mm, thickness: 350 μm) of the mixed body is prepared.

Thereafter, the disk-shaped molded material is placed on a substrate or the like, and sintering of the active material particles and formation of the electrolyte are promoted at 900° C. The heating treatment time was set to 8 hours.

By doing this, the active material portion was formed from the active material and an electron transfer pathway was formed, and also the positive electrode assembly in which the active material portion and the electrolyte were combined was formed. The thickness of the positive electrode was set to about 150 μm, the thickness of the electrolyte layer was set to about 15 μm, and the effective diameter was set to about 8 mm.

### Molding of Positive Electrode Using Fluorinated LCO and 540° C.-Calcined Body of (Li_{5.5}Ga_{0.5})(La_{2.96}Nd_{0.04})Zr₂O₁₂ in Example 14

A positive electrode and an electrolyte layer are molded using the fluorinated LCO of Example 1 as the active material and the 540° C.-calcined body of (Li_{5.5}Ga_{0.5})(La_{2.96}Nd_{0.04})Zr₂O₁₂ of Example 8 as the electrolyte calcined body. Specifically, 0.0450 g of the fluorinated LCO of Example 1 and 0.0550 g of the calcined body of Example 8 in a powder form are sufficiently stirred and mixed, whereby 0.1000 g of a mixed body is prepared.

The mixed body is compression molded using a molding die. For example, by using a molding die (a die with an exhaust port having an inner diameter of 10 mm), the mixed body is pressed at a pressure of 1019 MPa for 2 minutes, whereby a disk-shaped molded material (diameter: 10 mm, effective diameter: 8 mm, thickness: 350 μm) of the mixed body is prepared.

Thereafter, the disk-shaped molded material is placed on a substrate or the like, and sintering of the active material particles and formation of the electrolyte are promoted at 900° C. The heating treatment time was set to 8 hours.

By doing this, the active material portion is formed from the active material and an electron transfer pathway is formed, and also the positive electrode assembly in which the active material portion and the electrolyte are combined is formed. The thickness of the positive electrode was set to about 150 μm, the thickness of the electrolyte layer was set to about 15 μm, and the effective diameter was set to about 8 mm.

### Molding of Positive Electrode Using Non-Fluorinated LCO and Precursor Solution of Li_{6.3}La₃(Zr_{1.3}Sb_{0.5}Ta_{0.2})O₁₂ in Comparative Example 4

Molding is performed in the same manner as in Example 9 except that non-fluorinated LCO is used as the active material.

### Molding of Positive Electrode Using Non-Fluorinated LCO and Precursor Solution of (Li_{5.5}Ga_{0.5})(La_{2.96}Nd_{0.04})Zr₂O₁₂ in Comparative Example 5

Molding is performed in the same manner as in Example 10 except that non-fluorinated LCO is used as the active material.

### Molding of Positive Electrode Using Non-Fluorinated NMC and Precursor Solution of Li_{6.3}La₃(Zr_{1.3}Sb_{0.5}Ta_{0.2})O₁₂ in Comparative Example 6

Molding is performed in the same manner as in Example 12 except that non-fluorinated NMC is used as the active material.

### Molding of Positive Electrode Using Non-Fluorinated LCO and 540° C.-Calcined Body of Li_{6.3}La₃(Zr_{1.3}Sb_{0.5}Ta_{0.2})O₁₂ in Comparative Example 7

Molding is performed in the same manner as in Example 13 except that non-fluorinated LCO is used as the active material.

### Molding of Positive Electrode Using Non-Fluorinated LCO and 540° C.-Calcined Body of (Li_{5.5}Ga_{0.5})(La_{2.96}Nd_{0.04})Zr₂O₁₂ in Comparative Example 8

Molding is performed in the same manner as in Example 14 except that non-fluorinated LCO is used as the active material.

### Evaluation of Positive Electrode and Electrolyte Layer Evaluation of Battery Characteristics

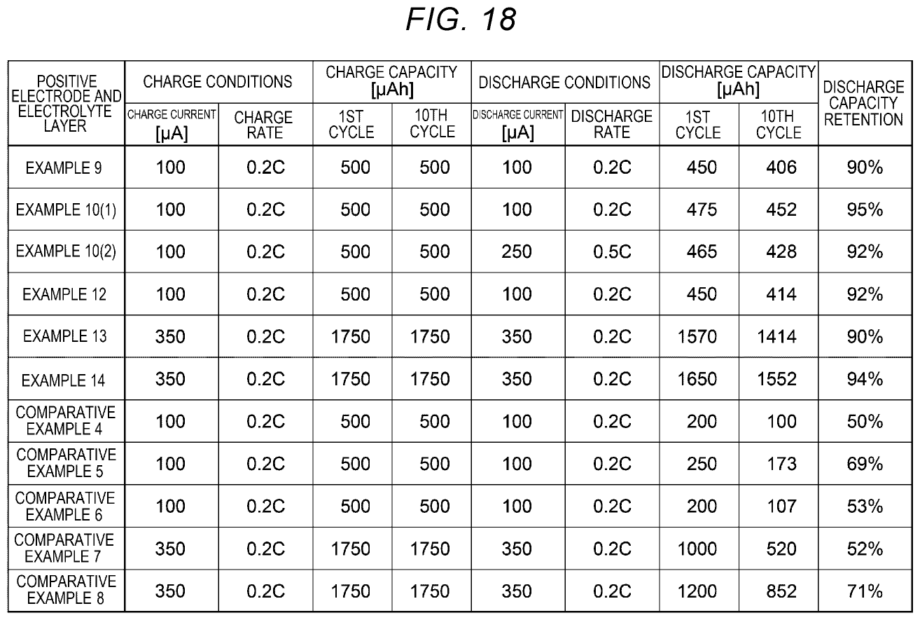

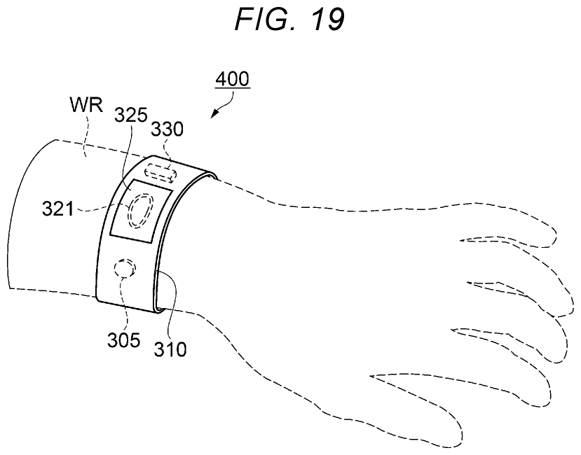

With respect to the positive electrodes and the electrolyte layers of Examples and Comparative Examples, charging and discharging were performed in an environment at 25° C., and the discharge capacity retention was evaluated as an index of the battery characteristics. The charge and discharge conditions at this time are shown in FIG. 18. FIG. 18 is a table showing the charge and discharge conditions and the evaluation results of the lithium batteries of Examples and Comparative Examples. In this evaluation, by using samples obtained by forming a metallic lithium foil having a thickness of about 150 μm as a negative electrode and a copper foil having a thickness of about 100 μm as each of a first current collector and a second current collector for the positive electrodes and the electrolyte layers of Examples and Comparative Examples as secondary batteries, evaluation was performed.

As shown in FIG. 18, in the positive electrodes and the electrolyte layers of Example 9, Example 10(1), Example 12, and Comparative Examples 4 to 6, the charge and discharge currents were set to 100 μA (charge and discharge rates: 0.2 C), and in Example 13, Example 14, Comparative Example 7, and Comparative Example 8, the charge and discharge currents were set to 350 μA (charge and discharge rates: 0.2 C), and in Example 10(2), the charge current was set to 100 μA (charge rate: 0.2 C), the discharge current was set to 250 μA (discharge rate: 0.5 C), and the evaluation was performed.

The charge and discharge capacities when the above-mentioned charging and discharging were repeated were measured. Specifically, the charge and discharge capacities at the initial time (1st cycle) and the charge and discharge capacities after repeating 10 cycles of charging and discharging (10th cycle) were measured, and the discharge capacity retention at the 10th charging and discharging cycle with respect to that at the 1st charging and discharging cycle was calculated. The results are shown in FIG. 18.

As shown in FIG. 18, when comparing Example 9 with Comparative Example 4, Example 10 with Comparative Example 5, Example 12 with Comparative Example 6, Example 13 with Comparative Example 7, and Example 14 with Comparative Example 8, respectively, it was found that the discharge capacity retention is improved in Examples as compared with Comparative Examples.

Further, as shown in FIG. 18, it was found that in any of the lithium batteries of Examples 9 to 14, a discharge capacity retention of 90% can be ensured. This showed that the lithium batteries of Examples have stable cycle characteristics and thus have excellent battery characteristics.

On the other hand, it was found that in the lithium batteries of Comparative Examples 4 to 8, the discharge capacity retention is as low as about 70% or less, and the cycle characteristics are not stable as compared with those of Examples, and the battery characteristics are poor.

### Second Embodiment

### Electronic Apparatus

An electronic apparatus according to this embodiment will be described with reference to FIG. 19. In this embodiment, a wearable apparatus will be described as an example of the electronic apparatus. FIG. 19 is a schematic view showing a configuration of a wearable apparatus as the electronic apparatus according to a second embodiment.

As shown in FIG. 19, a wearable apparatus 400 of this embodiment is an information apparatus that is worn on, for example, the wrist WR of a human body using a band 310 like a watch, and that obtains information on the human body. The wearable apparatus 400 includes a battery 305, a display portion 325, a sensor 321, and a processing portion 330. As the battery 305, the lithium battery of the above-mentioned embodiment is used.

The band 310 is formed in a belt shape using a resin having flexibility such as rubber so as to come into close contact with the wrist WR when it is worn. In an end portion of the band 310, a binding portion (not shown) capable of adjusting the binding position according to the thickness of the wrist WR is provided.

The sensor 321 is disposed at an inner face side (wrist WR side) of the band 310 so as to come into contact with the wrist WR when it is worn. The sensor 321 obtains information on the pulse rate, the blood glucose level, or the like of the human body when it comes into contact with the wrist WR, and outputs the information to the processing portion 330. As the sensor 321, for example, an optical sensor is used.

The processing portion 330 is incorporated in the band 310, and is electrically coupled to the sensor 321 and the display portion 325. As the processing portion 330, for example, an integrated circuit (IC) is used. The processing portion 330 performs arithmetic processing of the pulse rate, the blood glucose level, or the like based on the output from the sensor 321, and outputs display data to the display portion 325.

The display portion 325 displays the display data such as the pulse rate or the blood glucose level output from the processing portion 330. As the display portion 325, for example, a light-receiving type liquid crystal display device is used. The display portion 325 is disposed at an outer face side of the band 310 (a side opposed to the inner face where the sensor 321 is disposed) so that a wearer can read the display data when the wearer wears the wearable apparatus 400.

The battery 305 functions as a power supply source supplying power to the display portion 325, the sensor 321, and the processing portion 330. The battery 305 is incorporated in the band 310 in an attachable and detachable manner.

According to the above configuration, the wearable apparatus 400 can obtain information on the pulse rate or the blood glucose level of a wearer from the wrist WR and can display it as information such as the pulse rate or the blood glucose level through arithmetic processing or the like. Further, to the wearable apparatus 400, the lithium battery of the above-mentioned embodiment having an improved lithium ion conduction property and a large battery capacity in spite of having a small size is applied, and therefore, the weight can be reduced, and the operating time can be extended. Moreover, since the lithium battery of the above-mentioned embodiment is an all-solid-state secondary battery, the battery can be repeatedly used by charging, and also there is no concern about leakage of an electrolytic solution or the like, and therefore, the wearable apparatus 400 that can be used safely for a long period of time can be provided.

In this embodiment, a watch-type wearable apparatus is illustrated as the wearable apparatus 400, however, the apparatus is not limited thereto. The wearable apparatus may be a wearable apparatus to be worn on, for example, the ankle, head, ear, waist, or the like.

The electronic apparatus to which the battery 305 (the lithium battery of the above-mentioned embodiment) is applied as the power supply source is not limited to the wearable apparatus 400. As other electronic apparatuses, for example, a display to be worn on the head such as a head-mounted display, a head-up display, a portable telephone, a portable information terminal, a notebook personal computer, a digital camera, a video camera, a music player, a wireless headphone, a portable gaming machine, and the like are exemplified. These electronic apparatuses may have another function, for example, a data communication function, a gaming function, a recording and playback function, a dictionary function, or the like.

Further, the electronic apparatus of this embodiment is not limited to the use for general consumers and can also be applied to industrial use. In addition, the apparatus to which the lithium battery of the above-mentioned embodiment is applied is not limited to electronic apparatuses. For example, the lithium battery of the above-mentioned embodiment may be applied as a power supply source for a moving object. Specific examples of the moving object include automobiles, motorcycles, forklifts, and flying objects such as unmanned planes. According to this, a moving object including a battery having an improved ion conduction property as a power supply source can be provided.

Hereinafter, contents derived from the above-mentioned embodiments will be described.

The active material includes a composite metal oxide represented by the following formula (1), wherein the composite metal oxide contains lithium and fluorine, and also contains one or more types of elements selected from the group consisting of nickel, manganese, and cobalt.

LiₚNiₓMn_{2-x-y}CO_{y}O_{2-q}F_{q} (1)

In the formula (1), p, q, x, and y are real numbers satisfying 0.98≤p≤1.07, 0<q≤0.35, 0≤x≤1, and 0≤y≤1, respectively.

According to this configuration, a secondary battery in which the interface resistance is suppressed and the charge-discharge characteristics are improved is obtained.

In the active material described above, a fluorine concentration at a surface of the composite metal oxide may be larger than a fluorine concentration inside the composite metal oxide.

According to this configuration, a secondary battery in which the interface resistance is suppressed and the charge-discharge characteristics are further improved is obtained.

In the active material described above, the composite metal oxide may include LiCoOF, LiNiOF, LiMn₂O₃F, LiMn₂O₂F, or Liₚ(Mn_{1-x-y}CO_{y})OF.

According to this configuration, a secondary battery in which the interface resistance is suppressed and the charge-discharge characteristics are further improved is obtained.

The method for producing an active material includes a first step of mixing a lithium composite metal oxide containing lithium and one or more types of elements selected from the group consisting of nickel, manganese, and cobalt with a fluorinated organic polymer, thereby obtaining a mixture, a second step of heating the mixture in an inert gas atmosphere, thereby obtaining an intermediate product including a composite metal oxide represented by the following formula (1), and a third step of sintering the intermediate product in the atmosphere or in dry air.

LiₚNiₓMn_{2-x-y}CO_{y}O_{2-q}F_{q} (1)

In the formula (1), p, q, x, and y are real numbers satisfying 0.98≤p≤1.07, 0<q≤0.35, 0≤x≤1, and 0≤y≤1, respectively.

According to this production method, a secondary battery in which the interface resistance is suppressed and the charge-discharge characteristics are further improved is obtained.

The method for producing an active material includes a first step of mixing a lithium composite metal oxide containing lithium and one or more types of elements selected from the group consisting of nickel, manganese, and cobalt with a fluorinated organic polymer, thereby obtaining a mixture, a second step of heating the mixture in a reducing gas atmosphere, thereby obtaining an intermediate product including a composite metal oxide represented by the following formula (1), and a third step of sintering the intermediate product in the atmosphere or in dry air.

LiₚNiₓMn_{2-x-y}CO_{y}O_{2-q}F_{q} (1)

In the formula (1), p, q, x, and y are real numbers satisfying 0.98≤p≤1.07, 0<q≤0.35, 0≤x≤1, and 0≤y≤1, respectively.

According to this production method, a secondary battery in which the interface resistance is suppressed and the charge-discharge characteristics are further improved can be produced at low cost.

In the method for producing an active material described above, the fluorinated organic polymer may be polyvinylidene fluoride.

According to this production method, a secondary battery having improved charge-discharge characteristics can be efficiently produced.

In the method for producing an active material described above, in the first step, the lithium composite metal oxide and the polyvinylidene fluoride may be mixed at a molar ratio of 1:1.

According to this production method, a secondary battery having improved charge-discharge characteristics can be efficiently produced at low cost.

In the method for producing an active material described above, the fluorinated organic polymer may be polytetrafluoroethylene.

According to this production method, a secondary battery having improved charge-discharge characteristics can be efficiently produced.

In the method for producing an active material described above, in the first step, the lithium composite metal oxide and the polytetrafluoroethylene may be mixed at a molar ratio of 1:0.5.

According to this production method, a battery having improved charge-discharge characteristics can be efficiently produced.

The electrode assembly includes any of the active materials described above and an electrolyte.

According to this configuration, a secondary battery in which the interface resistance is suppressed and the charge-discharge characteristics are further improved is obtained.

The secondary battery includes the electrode assembly described above and a current collector.

According to this configuration, a secondary battery in which the interface resistance is suppressed and the charge-discharge characteristics are further improved is obtained.

The electronic apparatus includes the secondary battery described above.

According to this configuration, an electronic apparatus including a secondary battery having an improved ion conduction property as a power supply source can be provided.

What is claimed is:

1. An active material, comprising a composite metal oxide represented by the following formula (1), wherein
the composite metal oxide contains lithium and fluorine, and also contains one or more types of elements selected from the group consisting of nickel, manganese, and cobalt:
LiₚNiₓMn_{2-x-y}CO_{y}O_{2-q}F_{q} (1)
wherein p, q, x, and y are real numbers satisfying 0.98≤p≤1.07, 0<q≤0.35, 0≤x≤1, and 0≤y≤1, respectively.

2. The active material according to claim 1, wherein a fluorine concentration at a surface of the composite metal oxide is larger than a fluorine concentration inside the composite metal oxide.

3. The active material according to claim 1, wherein the composite metal oxide includes LiCoOF, LiNiOF, LiMn₂O₃F, LiMn₂O₂F, or Liₚ(Mn_{1-x-y}CO_{y})OF.

4. A method for producing an active material, comprising:
a first step of mixing a lithium composite metal oxide containing lithium and one or more types of elements selected from the group consisting of nickel, manganese, and cobalt with a fluorinated organic polymer, thereby obtaining a mixture;
a second step of heating the mixture in an inert gas atmosphere, thereby obtaining an intermediate product including a composite metal oxide represented by the following formula (1); and
a third step of sintering the intermediate product in the atmosphere or in dry air:
LiₚNiₓMn_{2-x-y}CO_{y}O_{2-q}F_{q} (1)
wherein p, q, x, and y are real numbers satisfying 0.98≤p≤1.07, 0<q≤0.35, 0≤x≤1, and 0≤y≤1, respectively.

5. A method for producing an active material, comprising:
a first step of mixing a lithium composite metal oxide containing lithium and one or more types of elements selected from the group consisting of nickel, manganese, and cobalt with a fluorinated organic polymer, thereby obtaining a mixture;
a second step of heating the mixture in a reducing gas atmosphere, thereby obtaining an intermediate product including a composite metal oxide represented by the following formula (1); and
a third step of sintering the intermediate product in the atmosphere or in dry air:
LiₚNiₓMn_{2-x-y}CO_{y}O_{2-q}F_{q} (1)
wherein p, q, x, and y are real numbers satisfying 0.98≤p≤1.07, 0<q≤0.35, 0≤x≤1, and 0≤y≤1, respectively.

6. The method for producing an active material according to claim 4, wherein the fluorinated organic polymer is polyvinylidene fluoride.

7. The method for producing an active material according to claim 6, wherein in the first step, the lithium composite metal oxide and the polyvinylidene fluoride are mixed at a molar ratio of 1:1.

8. The method for producing an active material according to claim 4, wherein the fluorinated organic polymer is polytetrafluoroethylene.

9. The method for producing an active material according to claim 8, wherein in the first step, the lithium composite metal oxide and the polytetrafluoroethylene are mixed at a molar ratio of 1:0.5.

10. An electrode assembly, comprising:
the active material according to claim 1; and
an electrolyte.

11. A secondary battery, comprising:
the electrode assembly according to claim 10; and
a current collector.

12. An electronic apparatus, comprising the secondary battery according to claim 11.
